(19) United States
(12) Patent Application Publication
(10) Pub. No.: US 2002/0194587 A1
(43) Pub. Date: Dec. 19, 2002

(54) Enhanced communication, monitoring and control system

(76) Inventors: David P. Lampton, Sausalito, CA (US); Sunil Rodrigues, Novato, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/093,839

(22) Filed: Mar. 8, 2002

Related U.S. Application Data
(60) Provisional application No. 60/275,822, filed on Mar. 13, 2001.

(51) Int. Cl. H04N 7/16; H04H 9/00; H04N 7/173

(52) U.S. Cl. 725/10; 725/109; 725/110

(57) ABSTRACT

An improved system, both method and apparatus for creating an enhanced virtual reality environment providing an integrated, universal, communication, monitoring and/or control experience, even for those compromised users typically denied such experience, the system providing newly emergent properties not present in the individual modules comprising the system, but for the synergy with each other created through the vehicle of the user's mind, the system having a display subsystem including video and/or audio capability, an r.f. and/or i.f. wireless link communication subsystem, including a set-top unit subsystem either integral or non-integral with the display subsystem, and either internal or external to the display subsystem, for communicating and coordinating a plurality of diverse functions with both a user and the display subsystem, and further includes a handset control unit for interactive, bi-directional communication by the user with the set-top subsystem, the control unit having at least simplified controls including a pair of visually and/or physically conspicuous adjacent input areas, e.g. NEXT and GO, providing a simplified total control interface for all system functions and adapted for easy, uncomplicated operation by users, including a relatively unskilled, handicapped or other compromised user who might otherwise have difficulty accessing and utilizing such system functions.

### RELATED APPLICATIONS

This application is claiming the benefit of a co-pending provisional application Serial No. 60/275,822 filed on Mar. 13, 2001.

### BACKGROUND OF THE INVENTION

1. Field of the Invention

This invention relates generally to an enhanced system for communication, monitoring and control and, more particularly, to a new and improved Internet based, two-way, video, voice, text and data communication and/or monitoring system whereby an environment of total interactive connectivity and comfortable immersion in the outside world is simulated for the user without concomitant need for technical proficiency, and further providing an enhanced gestalt for a new and more complex milieu akin to an old and familiar gestalt in a simpler, more comfortable milieu of direct interaction, all belying the greater complexity of the new system technology.

2. Description of the Related Art

Prior to this invention, to use video mail, video telephone, voice telephone or e-mail or to access the Internet typically required assembling and installing third party hardware and software into a PC and following technical setup and operating procedures that required a degree of “computer literacy” adequate to accomplish these tasks. Also, accessing PSTN, VOIP and/or VPN telephone service required separate telephone systems or telephone systems and computer systems. In addition, computer based systems did not have the convenience of use of conventional PSTN service.

Prior to the invention, handheld “PDAs” (Personal Digital Assistants) could only use the computational, storage and display power they contained internally and had to have their data periodically updated through manual downloads from a PC. Even combined cellular phone/PDAs did not have a dedicated computer capable of computationally intense features such as personalized voice prompting or voice accessed personal databases, and Internet access was at very low speed, limited by a cellular phone modem data rate 100 times slower that the broadband connection used in the present invention. In this regard, the limited cellular data rate is dictated by the limited RF spectrum available for cellular service.

Prior to this invention, to achieve a similar level of risk management, patients with potentially dangerous or unstable conditions needed to be in the same physical location as monitoring equipment and a qualified caregiver.

Prior to this invention, long distance communication was by voice only and required remembering and dialing arbitrary numbers to access the other person.

Accordingly, there has been a long existing need for a new and improved system, method and apparatus which obviates the aforedescribed and other difficulties in the prior art. The present invention clearly fulfills all these needs.

### SUMMARY OF THE INVENTION

Briefly, and in general terms, by way of example and not necessarily by way of limitation, the present invention provides easy access and use of video mail, video telephone, voice telephone, e-mail , Internet browsing and physiological monitoring with no technical knowledge or prior training required. Ease of use is equivalent to that of using a conventional cordless telephone. The Invention also includes a single user handset to receive and make voice telephone calls over PSTN lines, using VOIP service and using a VPN. In accordance with the practice of the present invention, all three types of service can be available simultaneously. Receiving calls from any service is just as convenient as standard PSTN service. When a call is received, the handset “rings” or announces the name of the caller and simply pushing a “Phone” button on the handset answers the call.

The invention also provides powerful communication and computational capabilities, including, but not limited to, a voice or display prompting calendar, voice controlled auto-dialing Internet IP telephony, emergency call service and high speed internet access through a compact, low cost RF wireless handset. The Invention also allows high speed Internet access through a wireless handset while conserving scarce RF bandwidth with a broadly deployed system. This is due to the limited range (approximately ½ mile or less) of the RF transmission from a local “mini-RF server” that has a copper wire or fiber optic high speed connection to the Internet and a short-range high bandwidth RF connection to the handset. This allows the same RF spectrum to be used by other “mini-RF servers” with less geographic spacing than would be required by a higher powered RF system of equivalent data bandwidth that serves many users simultaneously. In addition, the handset automatically switches functions and becomes a normal cellular telephone/modem when it is out of signal range of the mini-RF server.

Furthermore, this invention provides continuous, real time physiological data monitoring of a patient to a remote caregiver through a small wireless handset worn by the user that accepts analog or digital signals from physiological monitoring devices such as portable EKGs, etc. The handset contains a microphone and a loudspeaker and/or vibrator or lights that allow the remote caregiver to both query and warn the patient in real time if a dangerous condition is detected and call for emergency help if warranted.

Over millennia, humans worldwide have evolved a natural social structure based upon multi-generational family units whose members live in close physical proximity. There are many reasons why this particular structure has evolved, including the protection, care giving, close social connection, pooling of talents and sense of purpose it provides for its members. In the last 100 years, the fabric of this social structure has been torn apart by rapid technological advances that have created a “Familial Diaspora” in which different generations of a family typically live far apart and are isolated. This situation has caused a reduction in the quality of life for many people, especially isolated senior family members who no longer can easily and frequently connect with their children. The present invention specifically addresses this situation by providing a low cost, humanly natural, “always present” path for spontaneous visual and auditory “virtual visits” between family members, friends, care givers and their patients, etc. The paradigm for the functioning and functionality of the invention is to use technology to provide, over distance, the closest possible approximation of the natural and spontaneous communication that occurs between people who are together in the same space.

In a presently preferred embodiment of the invention, by way of example and not necessarily by way of limitation, the present invention includes an improved system for creating an enhanced virtual reality environment providing an integrated, universal, communication, monitoring and/or control experience, even for those compromised users typically denied such experience, the system providing newly emergent properties not present in the individual modules of the system, but for the synergy with each other created through the vehicle of the user's mind, the system including a display subsystem including video and/or audio capability, an r.f. and/or i.f. wireless link communication subsystem, the latter subsystem including at least a set-top unit subsystem either integral or non-integral with the display subsystem, and either internal or external to the display subsystem, for communicating and coordinating a plurality of diverse functions with both a user and the display subsystem, and further includes a handset control unit for interactive, bi-directional communication by the user with the set-top subsystem, the control unit having at least simplified controls including a pair of visually and/or physically conspicuous adjacent input areas, e.g. “GO” and “NEXT” functions, providing a simplified total control interface for all system functions and adapted for easy, uncomplicated operation by users, including a relatively unskilled, handicapped or other compromised user who may otherwise have difficulty accessing and utilizing such system functions, whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology and wherein the greater complexity of the system technology is actually perceived by the user as greater simplicity.

All of the above and other features of the invention are facilitated by appropriate software for providing/enabling the functions in the illustrated and equivalent embodiments of the present invention, to “make it happen” in achieving a new and improved Internet based, two-way, video, voice, text and data communication and monitoring system whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology.

In one aspect of the practice of the present invention, programming can be changed in the system by the user via the handset control unit and/or the set-top unit and may also be changed by external sources and information received over the Internet.

Hence, the present invention satisfies a long existing need in the art for an enhanced communication, monitoring and control system, particularly for relatively compromised users.

The above and other objects and advantages of the invention will become apparent from the following more detailed description, when taken in conjunction with the accompanying drawings of illustrative embodiments.

### BRIEF DESCRIPTION OF THE DRAWINGS

FIG. 1 is a combined block diagram and flowchart of a portion of a system for practice of the present invention;

FIG. 2 illustrates one embodiment of a handset control unit and its functions, in accordance with the invention;

FIG. 3 is a block diagram illustrating one embodiment of a suitable set-top subsystem architecture, in accordance with the invention;

FIGS. 4a and 4b are block diagrams of a remote control system comprising a handset and a base station, in accordance with the invention;

FIG. 5 is an enlarged view of a handset control unit;

FIG. 6 is a block diagram of a transceiver/camera module suitable for use in practicing the present invention;

FIGS. 7 through 21 depict typical video screens and audio scripts used in the practice of the present invention; and

FIGS. 22-34 are combined block diagrams and flowcharts for examples of typical navigation within the system of the present invention utilizing the appropriate video screens and audio scripting.

### DETAILED DESCRIPTION OF THE PREFERRED EMBODIMENTS

Glossary of Terms

connectME^{SM}:

An enhanced communication, monitoring and control system and service in accordance with the invention.

VPN: Virtual Private Network

VPN technology allows creation of a secure private network using public communication channels. This is done with encryption technology in conjunction with PPTP tunneling software that allows specially modified data packets to pass through a firewall in and out of a LAN (Local Area Network).

VOIP: Voice Over IP (Internet Protocol)

VOIP technology converts a telephone call into IP data packets which are then routed over the Internet and converted back to standard telephone format and connected to a PSTN by a specialized server.

PSTN: Public Switched Telephone Network

PSTN carries conventional telephone service.

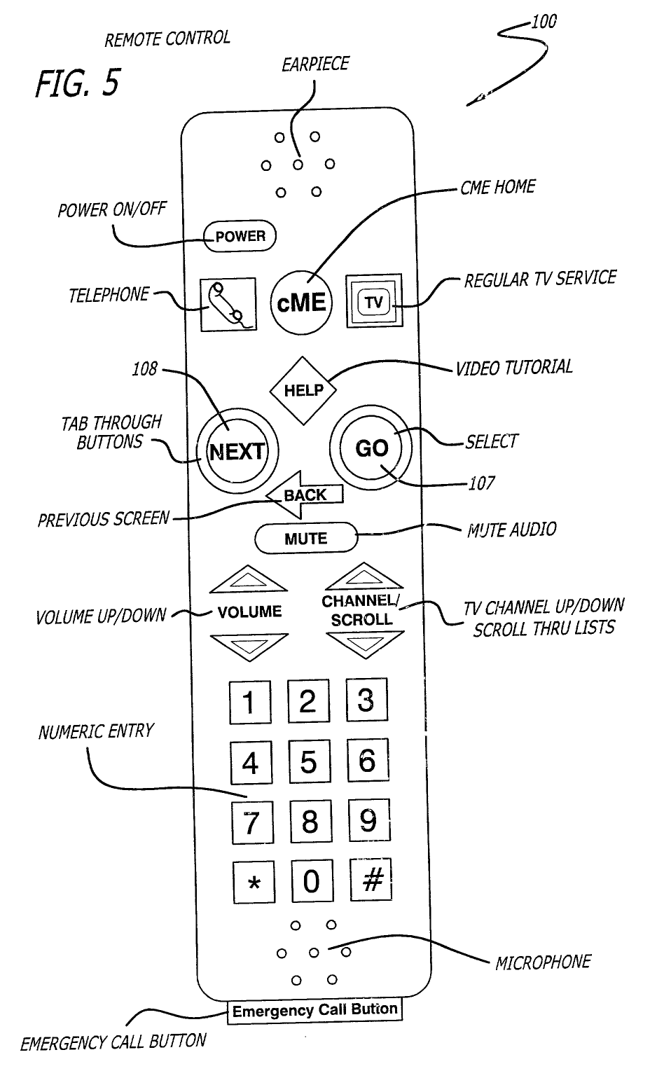

Referring now to the drawings, wherein like or corresponding reference numerals designate like or corresponding parts/systems/subsystems/components and the like throughout the drawings, a “virtual remote control” system is created through a combination of unique software control of digital processing, storage and image generation, RF/IR (radio frequency/infrared) wireless communication, video and audio displays and a relatively simple wireless user control handset 100 (FIGS. 2 and 5) which provides uniquely simple control and use of video and audio telephone and mail service, video and audio recording and playback, Web browsing, e-mail, data transmission and the like. The virtual remote's adaptive software user interface generates video and voice feedback, learns user preferences and is basically controlled typically by only two oversized push buttons, e.g. “GO” and “NEXT” buttons, 107, 108, respectively, on the user handset or by simple voice commands.

The present invention provides easy access and use of video mail, video telephone, voice telephone, e-mail and Internet browsing and physiological monitoring capability with no technical knowledge or prior training required on the part of the user. Ease of use is equivalent to that of using a conventional cordless telephone. The Invention also contemplates a single user handset for receiving and making voice telephone calls over PSTN lines, using VOIP service and using a VPN. All three types of service may be available simultaneously. Receiving calls from any service is just as convenient as standard PSTN service. When a call is received, the handset “rings” or announces the name of the caller, and pushing the “Phone” button on the handset unit 100 then answers the call.

The invention also provides powerful communication and computational capabilities, including, but not limited to, a voice or display prompting calendar, voice controlled auto-dialing Internet IP telephony, emergency call service and high speed Internet access through a compact, low cost RF wireless handset. The invention also enables use of high speed Internet access through the wireless handset unit 100 while conserving scarce RF bandwidth with a broadly deployed system. This is due to the limited range, approximately 3½ miles or less, of the RF transmission from a local “mini-RF server” that typically has a copper wire or fiber optic high speed connection to the Internet and a short-range high bandwidth RF connection to the handset. This allows the same RF spectrum to be used by other “mini-RF servers” with less geographic spacing between users than would be otherwise required by a higher powered RF system of equivalent data bandwidth that serves many users simultaneously. In addition, the handset unit 100 automatically switches functions and becomes a normal cellular telephone/modem when it is out of signal range of the mini-RF server.

The invention also facilitates continuous, real time physiological data monitoring of a patient to a remote caregiver through a small wireless handset (not shown) worn by the user that accepts analog or digital signals from physiological monitoring devices such as portable EKGs, etc. The handset contains a microphone and a loudspeaker and/or vibrator or lights that allow the remote caregiver to both query and warn the patient in real time if a dangerous condition is detected, and to call for emergency help if warranted.

The practice of the present invention provides a low cost, humanly natural, “always present” path for spontaneous visual and auditory “virtual visits” between family members, friends, care givers and their patients, etc. The paradigm for the functioning and functionality of the invention is to use technology to provide, over distance, the closest possible approximation of the natural and spontaneous communication that occurs between people who are together in the same space.

The various features of the invention are further facilitated by appropriate software for providing/enabling the functions in the illustrated and equivalent embodiments to “make it happen” in achieving a new and improved Internet based, two-way, video, voice, text and data communication, monitoring and control system whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology.

Programming can be changed in the system by the user via the handset control unit 100 and/or a set-top unit 101 and may also be changed by external sources and information received over the Internet.

In a presently preferred embodiment of the invention, by way of example and not necessarily by way of limitation, the present invention includes an improved system for creating an enhanced virtual reality environment providing an integrated, universal, communication, monitoring and/or control experience, even for those compromised users typically denied such experience. The system provides newly emergent properties not present in the individual modules of the system, but for the collective synergy with each other created through the vehicle of the user's mind.

The system of the present invention encompasses a display subsystem including video and/or audio capability, an r.f. and/or i.f. wireless link communication subsystem, the communication subsystem including at least a set-top unit 101 subsystem which can be either integral or non-integral with the display subsystem, and either internal or external to the display subsystem, for communicating and coordinating a plurality of diverse functions with both a user and the display subsystem. The present invention further includes a handset control unit 100 for interactive, bi-directional communication by the user with the set-top subsystem 101, the control unit 100 having at least simplified controls including a pair of visually and/or physically conspicuous adjacent input areas, such as a “GO” button 107 and a “NEXT” or “CONNECT” button 108, providing a simplified total control interface for all system functions and adapted for easy, uncomplicated operation by users, including a relatively unskilled, handicapped or other compromised user who may otherwise have difficulty accessing and utilizing such system functions.

In this way as previously indicated, an environment of total interactive connectivity and comfortable immersion in the outside world is simulated for the user without concomitant need for technical proficiency, providing an enhanced gestalt for a new and more complex milieu akin to an old and familiar gestalt in a simpler, more comfortable milieu of direct interaction between the user and other people, data sources and the like, all belying the much greater complexity of the new system technology and wherein the greater complexity of the system technology is actually perceived by the user as greater simplicity.

In accordance with the invention, a TV subsystem may include an internal or external, integrated or stand alone set-top box subsystem 101 that contains: a CPU, ram, hard disk data storage, running a unique custom software application that controls; graphics and video generation, high speed internet data reception and transmission using a plug-in internal or external cable or DSL modem or the like, data storage and retrieval, a conventional telephone service telephone modem, two way RF/IR audio/data transmission to a combination remote control/telephone/data transceiver user handset 100 over up to a half mile distance, a printer port, a video camera input port, a microphone input port and IR signal control of a TV set, and relaying RF transmitted commands from the user handset.

An external video camera that connects to the set-top box subsystem 101 may also provide the video image of the caller during video phone and video mail use.

An RF data and audio transceiver, antenna, video camera, and digital video encoder may be contained within a single compact housing with a digital data I/O connection, such as USB, to carry combined video, audio and control data to and from an internal/external set-top box subsystem or PC. The device may optionally contain a microphone and digital audio encoder. This single device allows the connectME^{SM} service to operate using a set-top boxes and PCs not specifically equipped to support connectME^{SM}.

A wireless RF/IR transmit and receive communication and control handset that integrates remote control, telephone, speaker phone, data transceiver, loudspeaker, microphone and, optionally, biometric ID functions. The handset can contain a graphic display and/or individually lit buttons that can be dynamically configured by RF signals from the set top box. The control interface of the handset has been deliberately simplified to take advantage of video and voice prompting and feedback from the set top box user interface software and hardware. The speakerphone function provides hands free audio transmission and reception, out of camera range, during videophone use.

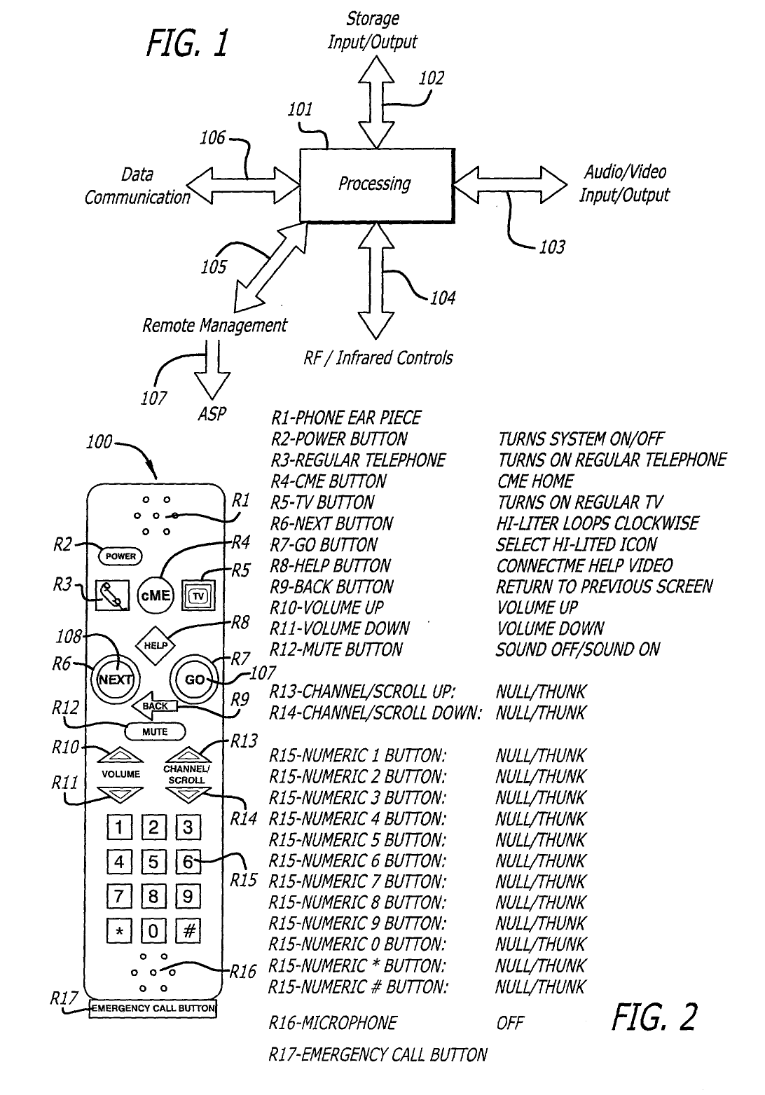

Referring now to FIG. 1 of the drawings, which illustrates an overall block diagram and data flow for a typical, basic set-up subsystem in accordance with the invention, central processing 101, provides bidirectional communication and control over links 102-106 for Storage Input/Output, Audio/Video Input/Output, RF/lnfrared Controls, Remote Management and Data Communication, respectively. Remote Management may also connect with “ASP” over a link 107.

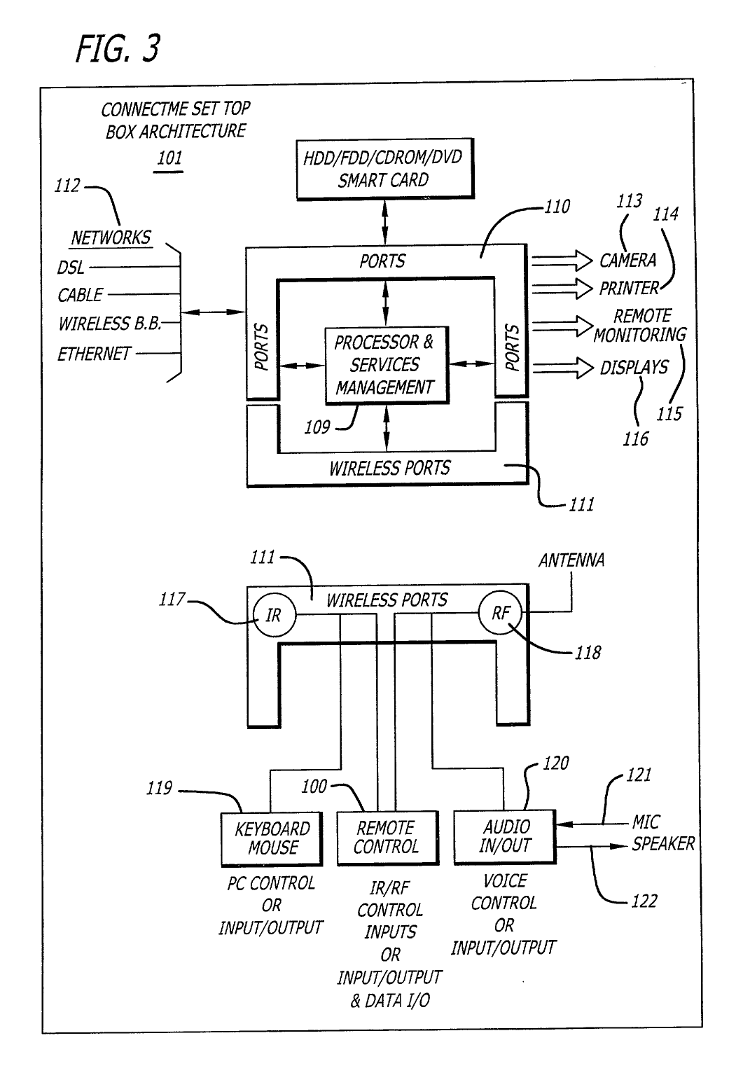

Further details of a suitable set-top subsystem architecture are shown in FIG. 3. The basic architecture is that of a single board PC design similar to an ATX style motherboard. It is expected that such generic set-tops will be the units over which connectME^{SM} services can be deployed. The operating system on set-tops deployed by connectME^{SM} is typically Linux because of better stability, open source and the opportunity of sizing the footprint to the specific requirements of the present system. It is possible that other users of the connectME^{SM} solution may use other operating systems without departing from the spirit and scope of the present invention. The required porting to those platforms would then have to be carried out for compatibility of design.

As indicated in FIG. 3, the process and services management 109 is connected to a network of ports 110 and wireless ports 111, which communicate bidirectionally and/or unidirectionally with Networks 112, including but not limited to DSL, cable, wireless BB, Internet, etc., as well as a Camera 113, a Printer 114, a Remote Monitoring System 115, and various displays 116.

The wireless ports subsystem 111 also includes IR (infrared) 117 and RF (radio frequency) 118 in communication with a keyboard mouse 119, a Remote Control such as the control unit 100 (see FIGS. 2 and 5), and an Audio In/Out subsystem 120 which receives input from a microphone 121 and directs output to a speaker 122. The subsystem units 100, 119 and 120, operate in connection with appropriate PC control or Input/Output, IR/RF Control Inputs or Input/Output, Voice Control or Input/Output, and Data Input/Output.

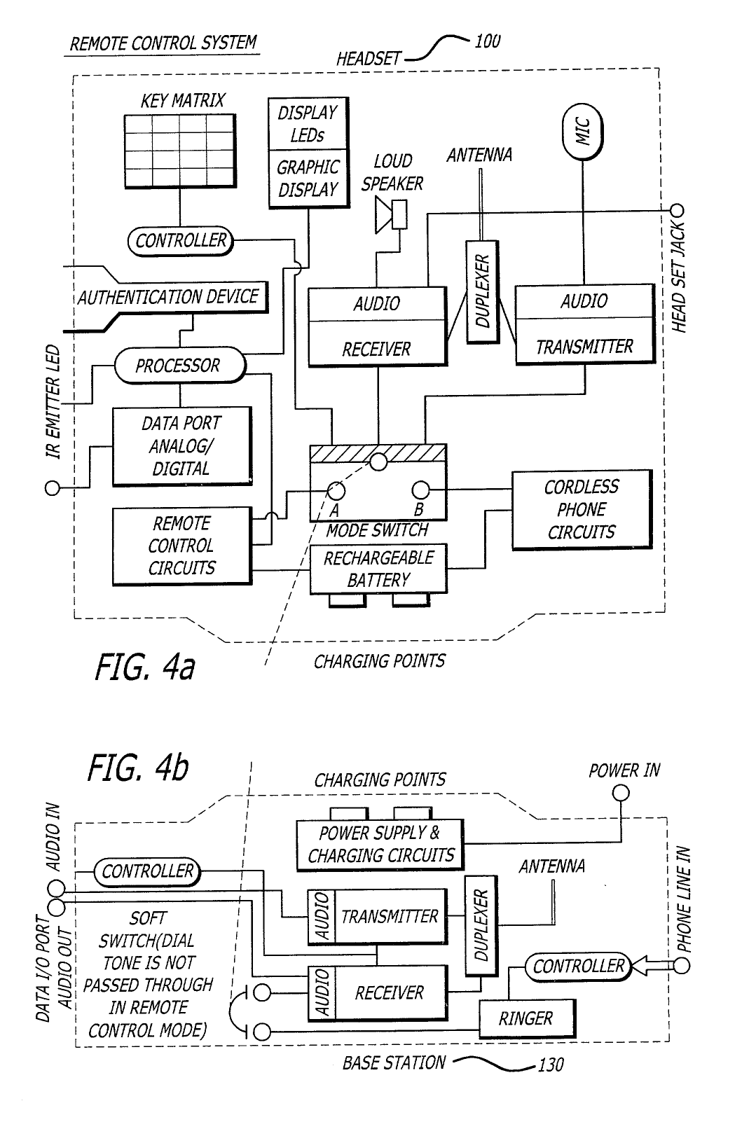

The remote control subsystem for the handset 100 and a corresponding base station 130 are shown in FIGS. 4a, 4b, respectively. The internal structure and functions of the remote control subsystem are amply illustrated by appropriate schematic layouts, connections and functional labels set forth in these FIGS. 4a, 4b as a typical example of one embodiment of a subsystem suitable for practice of the present invention by one of ordinary skill in the art.

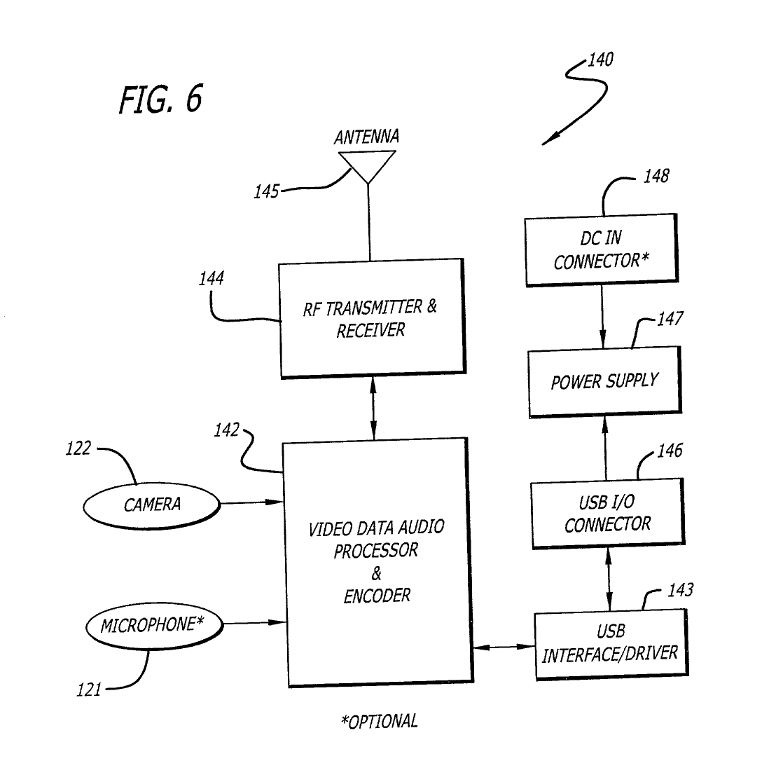

A typical RF Transceiver/Camera Module/subsystem 140 is illustrated in FIG. 6 of the drawing, and includes, by way of example and not necessarily by way of limitation, a microphone 121, a camera 122, a video and audio data processor & encoder 142, the latter being bidirectionally linked to an RF transmitter & receiver 144 and an appropriate antenna 145.

The video and audio processor 142 is also in bidirectional communication with an appropriate USB interface/driver 143, which, in turn, is connected to a USB I/O connector 146 that connects with a suitable power supply 147 and optional DC connector 148.

The following Table of Drawing Figures, associated screen numbers and names, further facilitates an understanding of practice of the invention.

TABLE A
FOR DRAWING FIGURES AND
ASSOCIATED SCREEN NUMBERS AND NAMES

| FIGURE | SCREEN | SCREEN |
|---|---|---|
| NO. | NO. | NAME |
| 7 | 001 | 001CME HOME |
| 8 | 002 | 002 MAIL CENTER |
| 9 | 003 | 003 VIDEO MAIL INBOX |
| 10 | 004 | 004 VIDEO MAIL - SENT MAIL |
| 11 | 005 | 005 VIDEO MAIL - VIEW SENT |
| | | MAIL |
| 12 | 006 | 006 VIEW VIDEO MAIL |
| 13 | 007 | 007 MAKE VIDEO MAIL |
| 14 | 008 | 008 RECORDING VIDEO MAIL |
| 15 | 009 | 009 DONE RECORDING VIDEO |
| | | MAIL |
| 16 | 010 | 010 SEND VIDEO MAIL |
| 17 | 011 | 011 MAIL HAS BEEN SENT |
| | | OVERLAY |
| 18 | 012 | 012 MAIL HAS BEEN SAVED |
| | | OVERLAY |
| 19 | 013 | 013 ARE YOU SURE YOU WANT |
| | | TO DELETE OVERLAY |
| 20 | 014 | 014 MAIL HAS BEEN DELETED |
| | | OVERLAY |
| 21 | 015 | 015 MAIL HAS BEEN ARCHIVED |

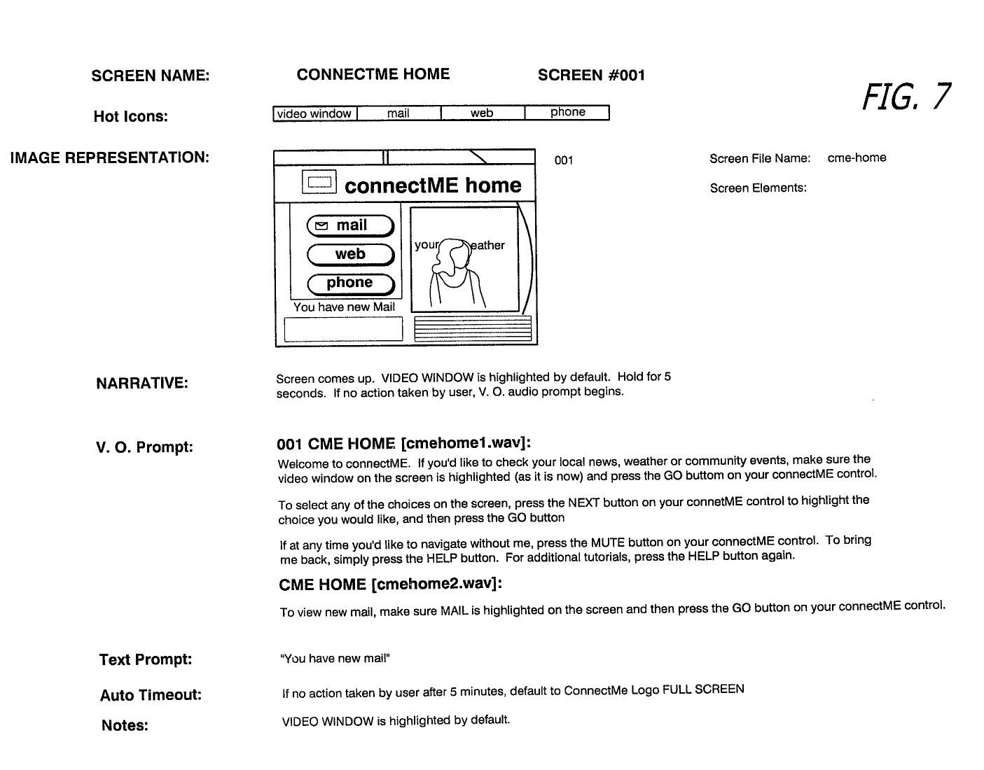

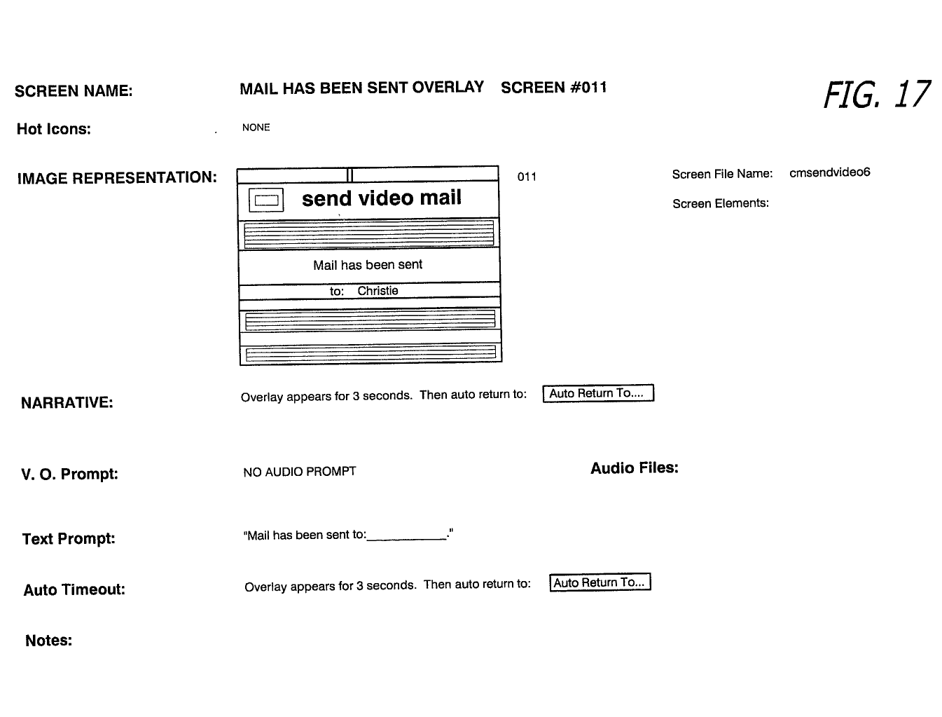

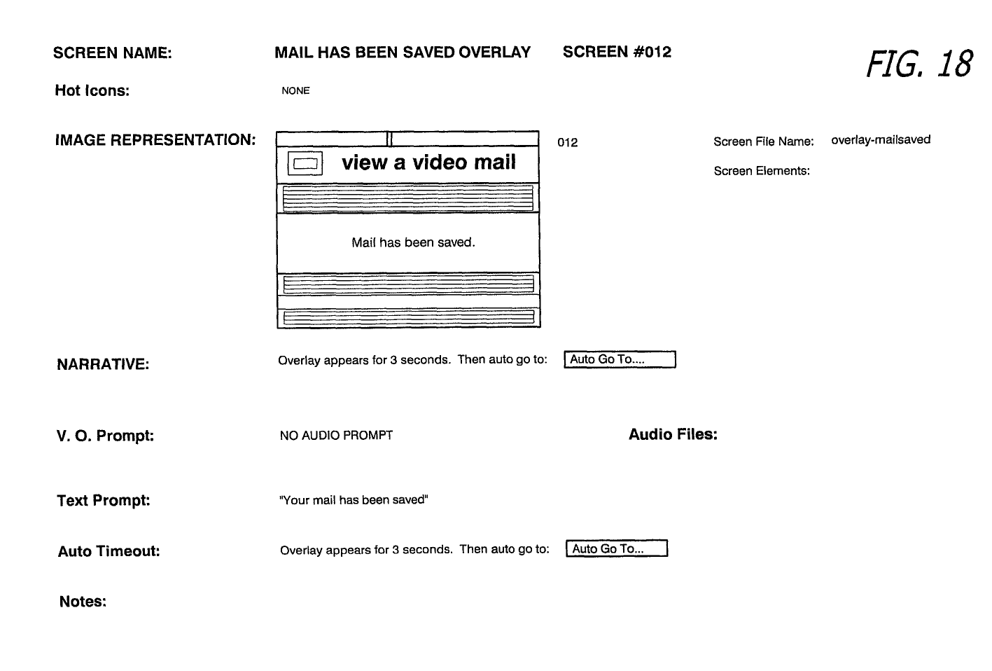

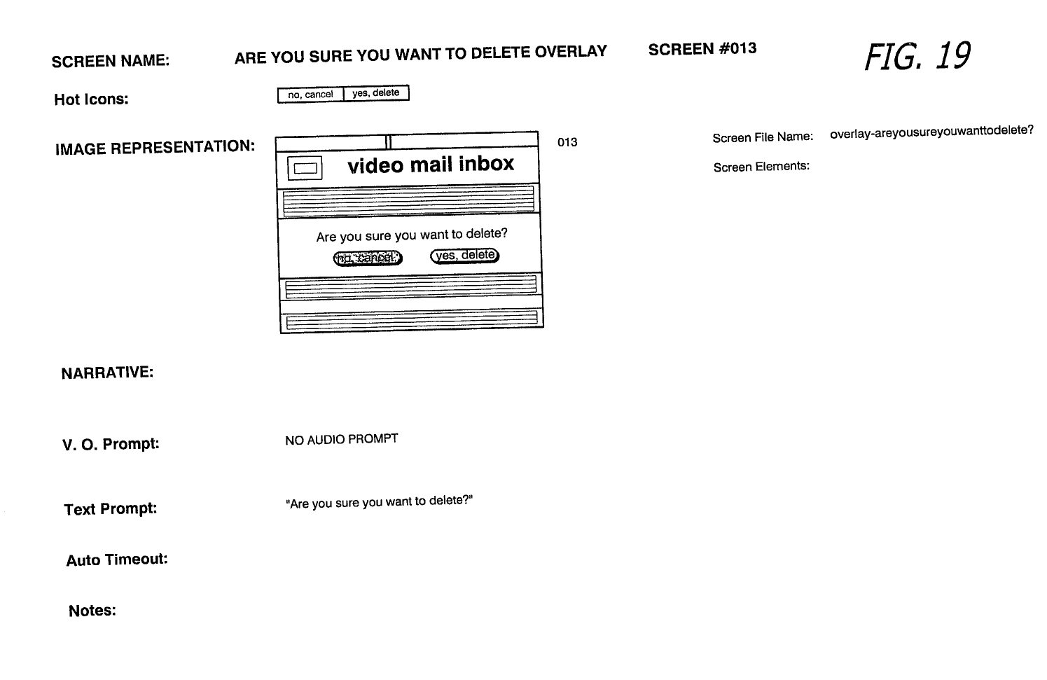

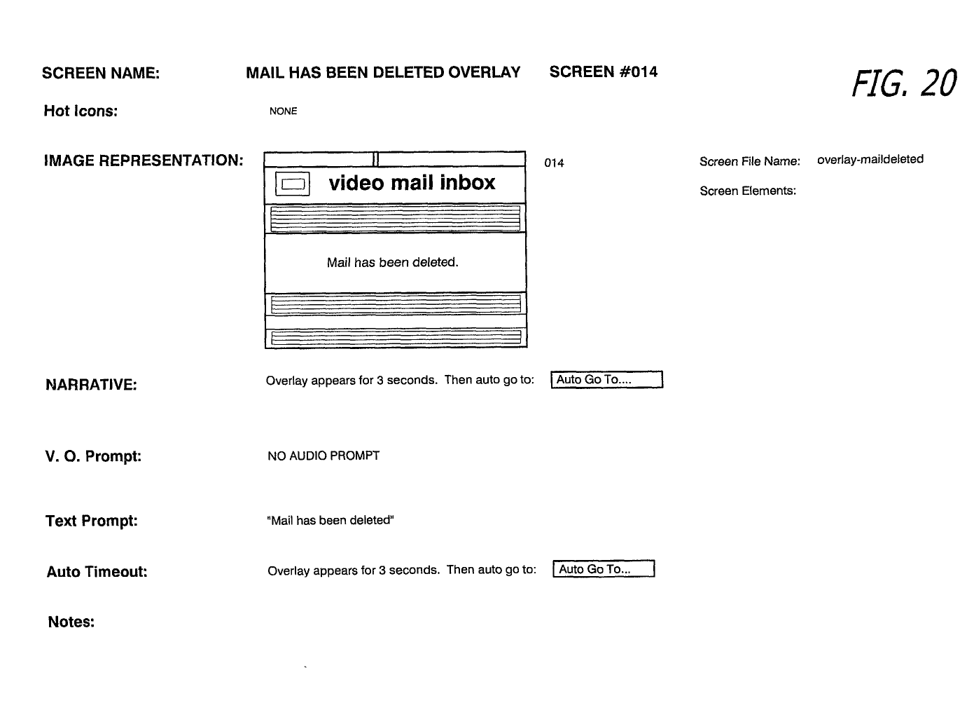

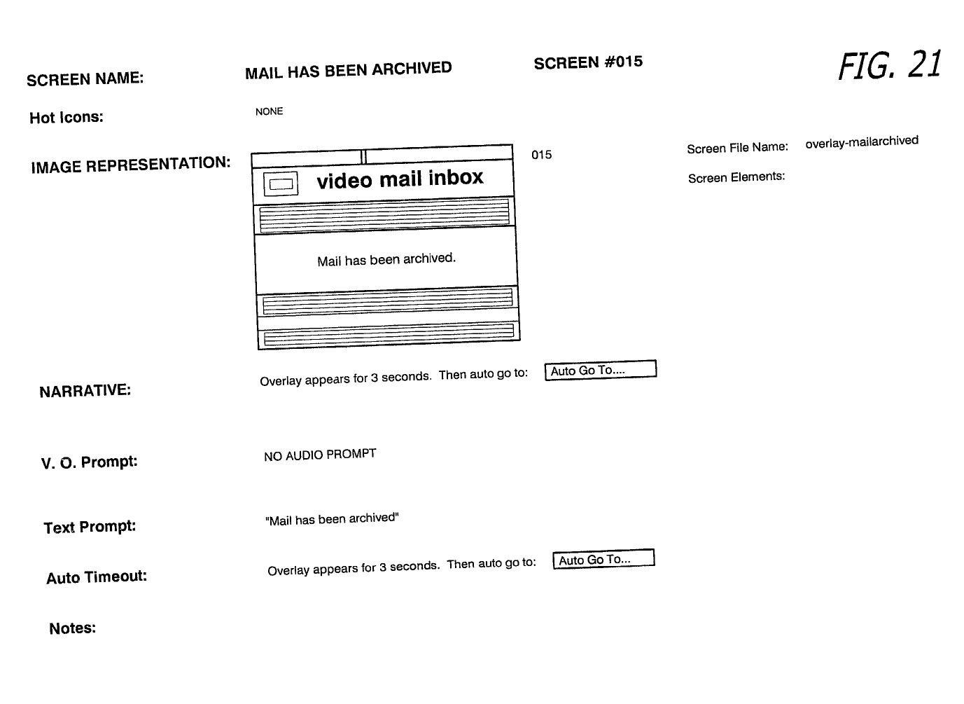

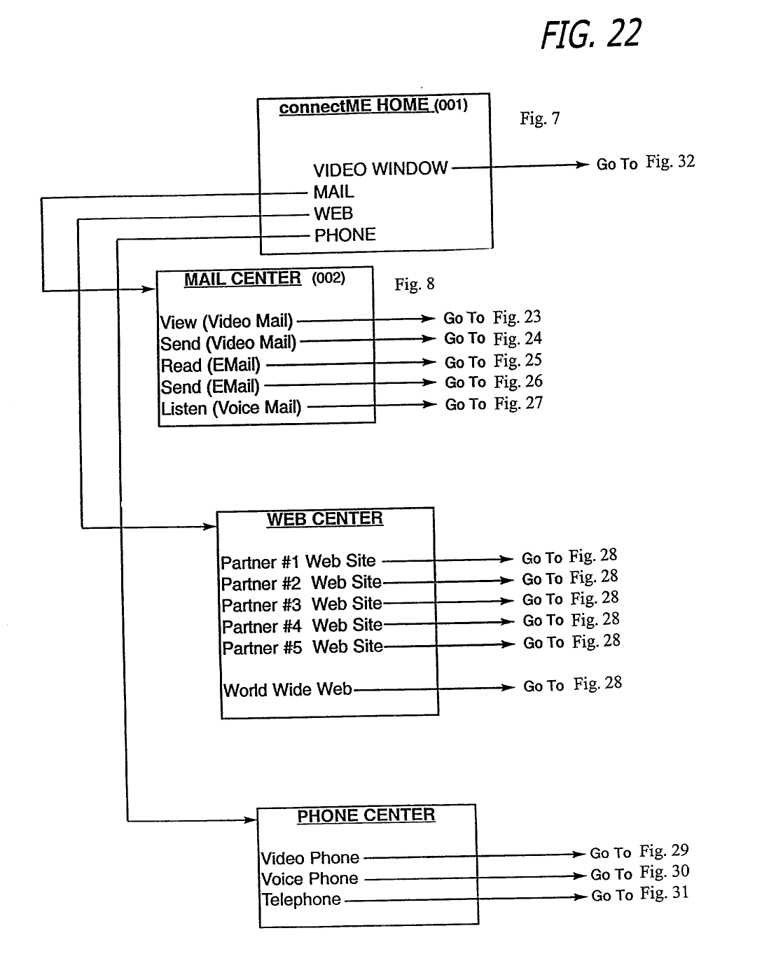

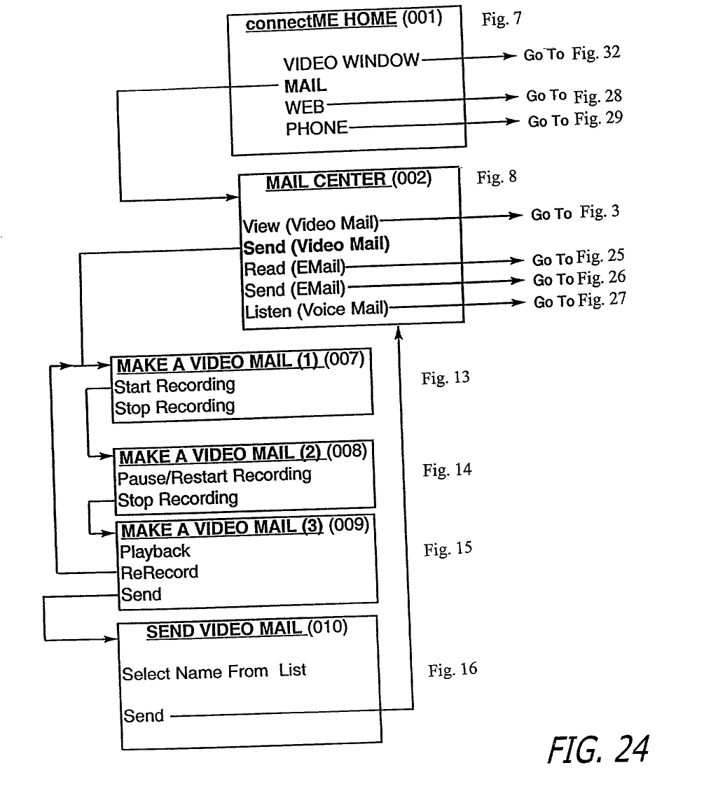

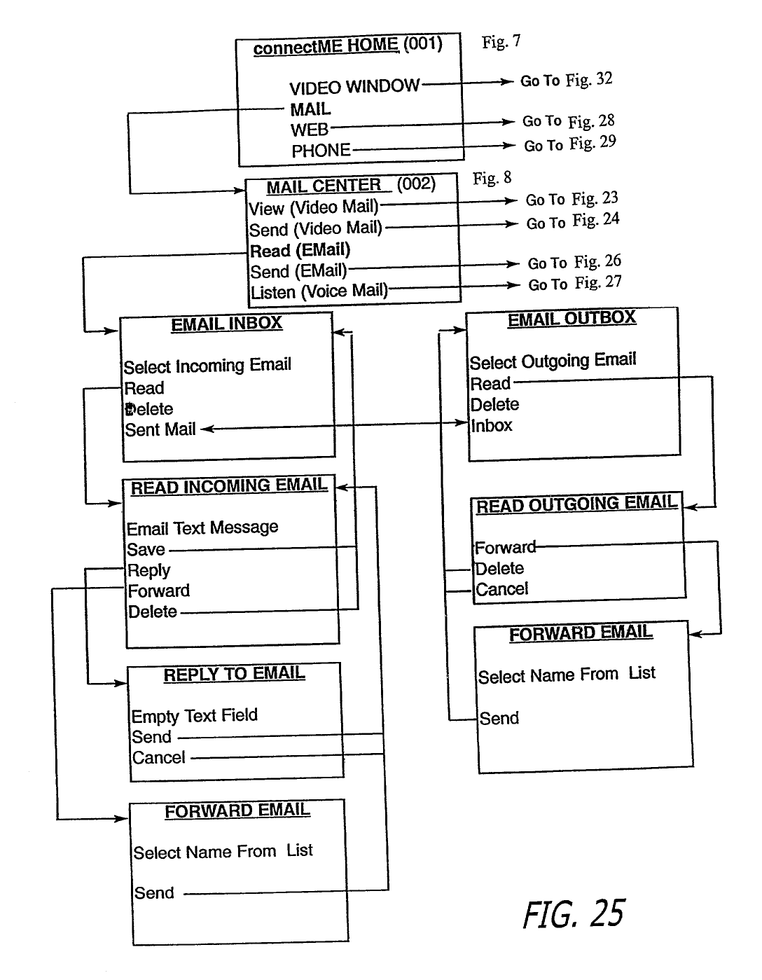

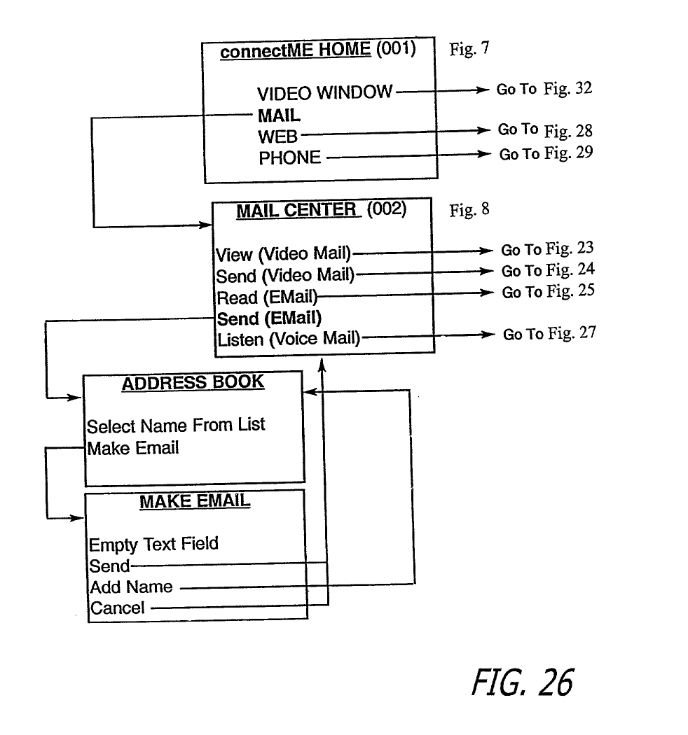

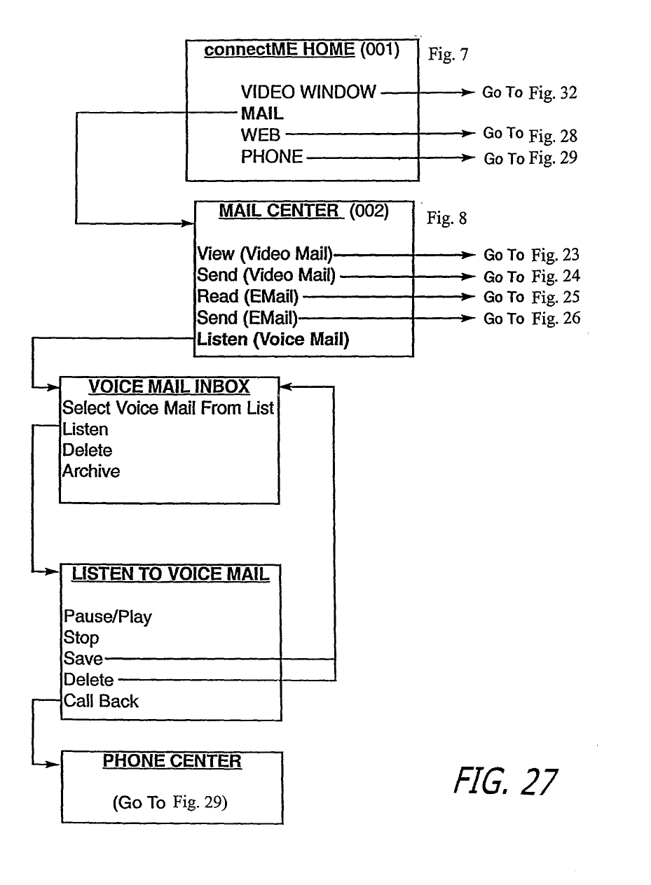

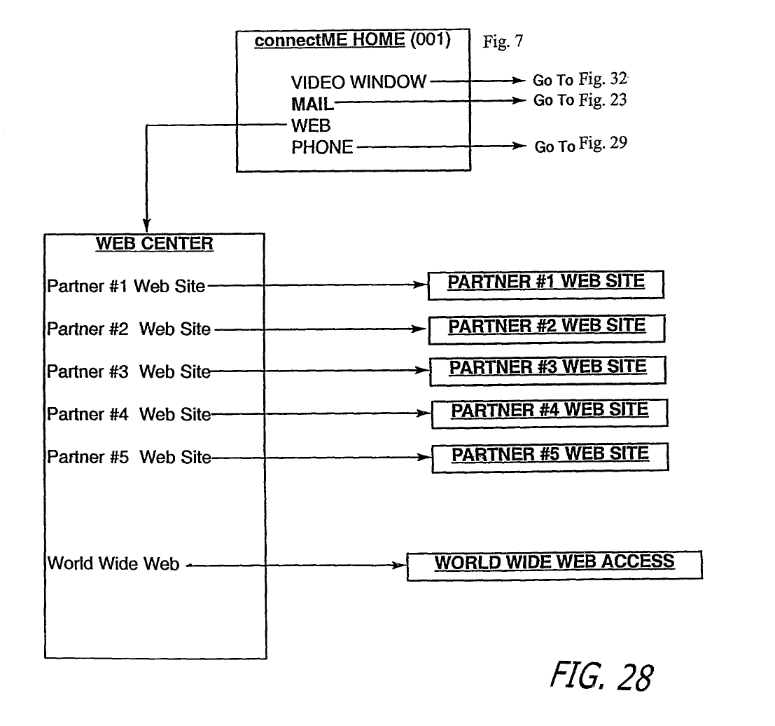

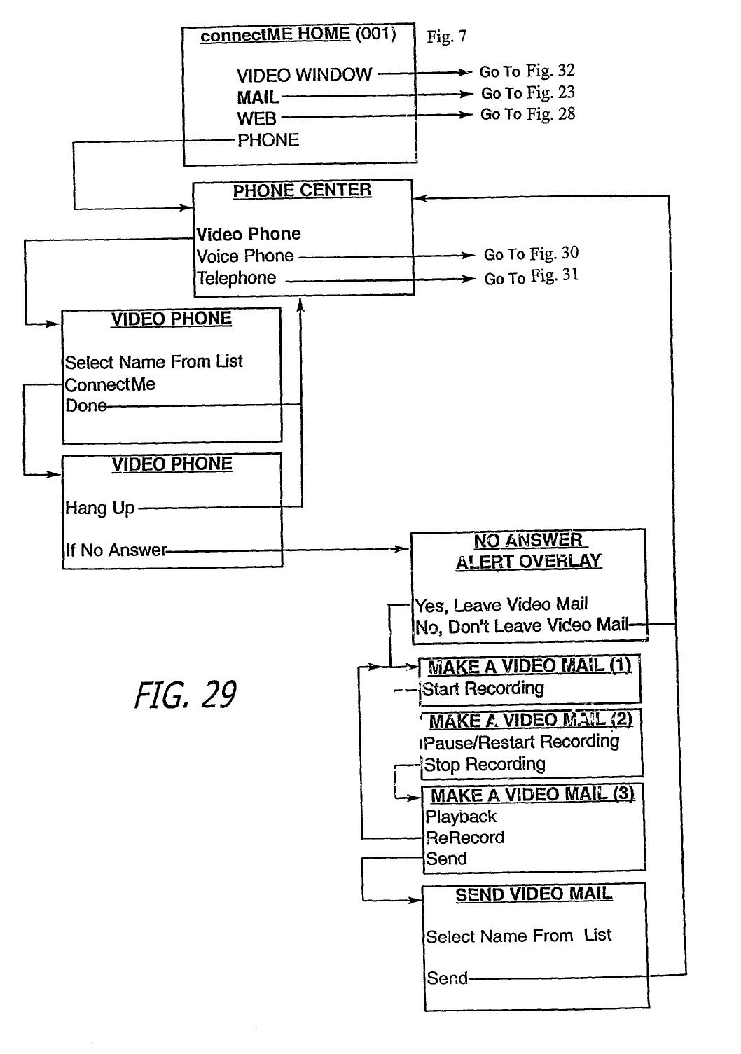

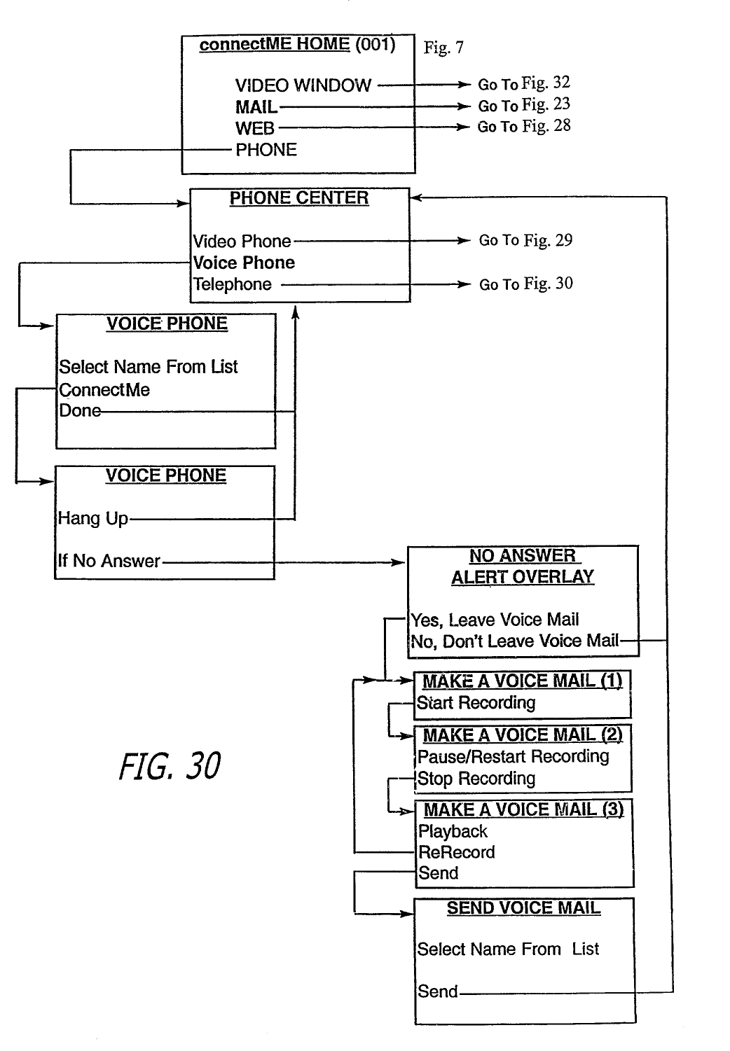

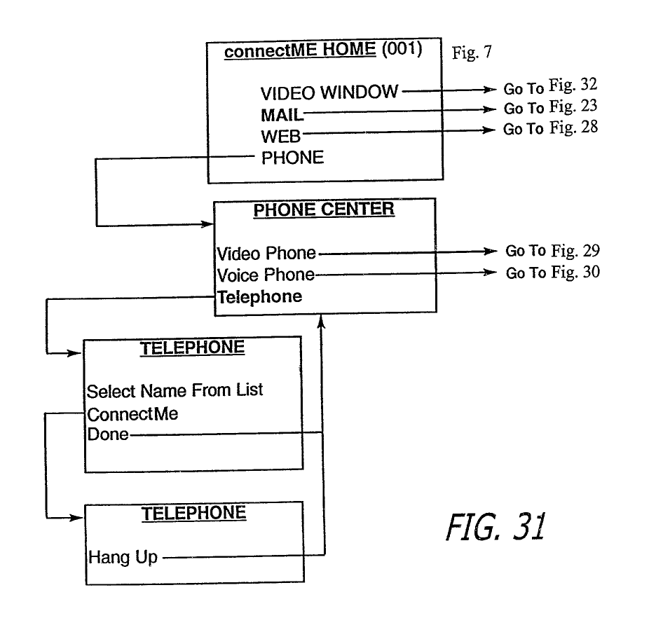

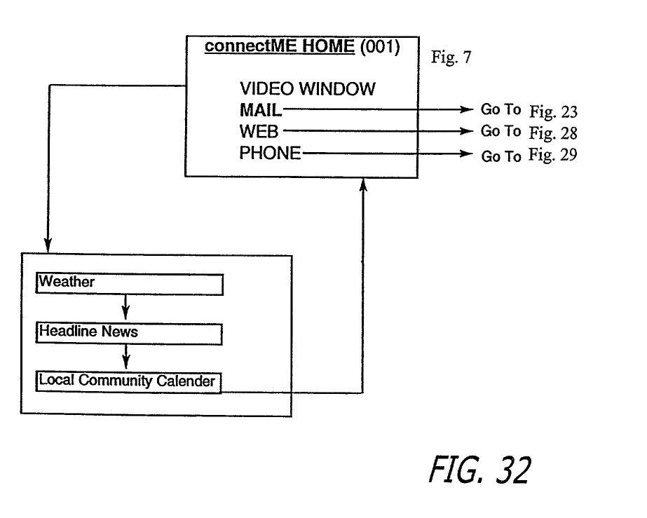

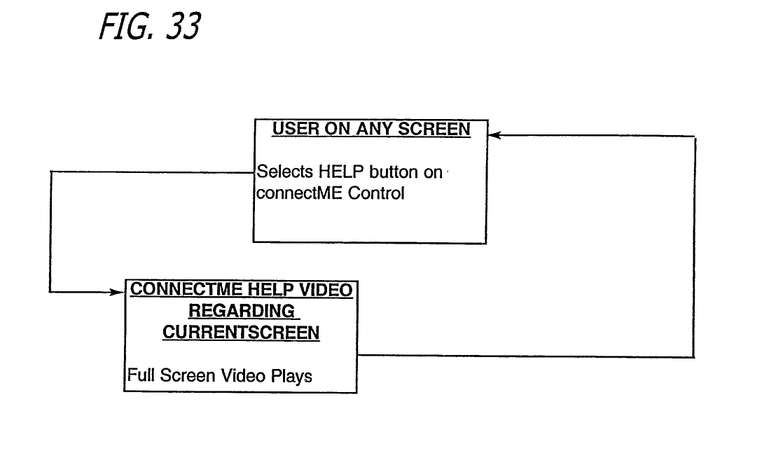

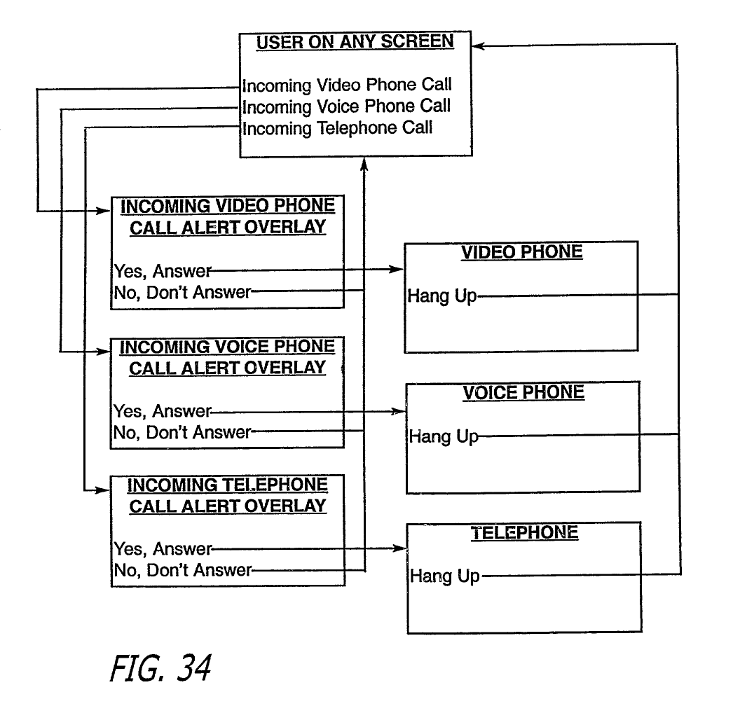

Examples of the structure and function of the system and method of the present invention are set forth in the following more detailed description relating to specific examples of screens, prompts and navigation shown in FIGS. 7-34 of the drawings which are labeled so as to be self-explanatory.

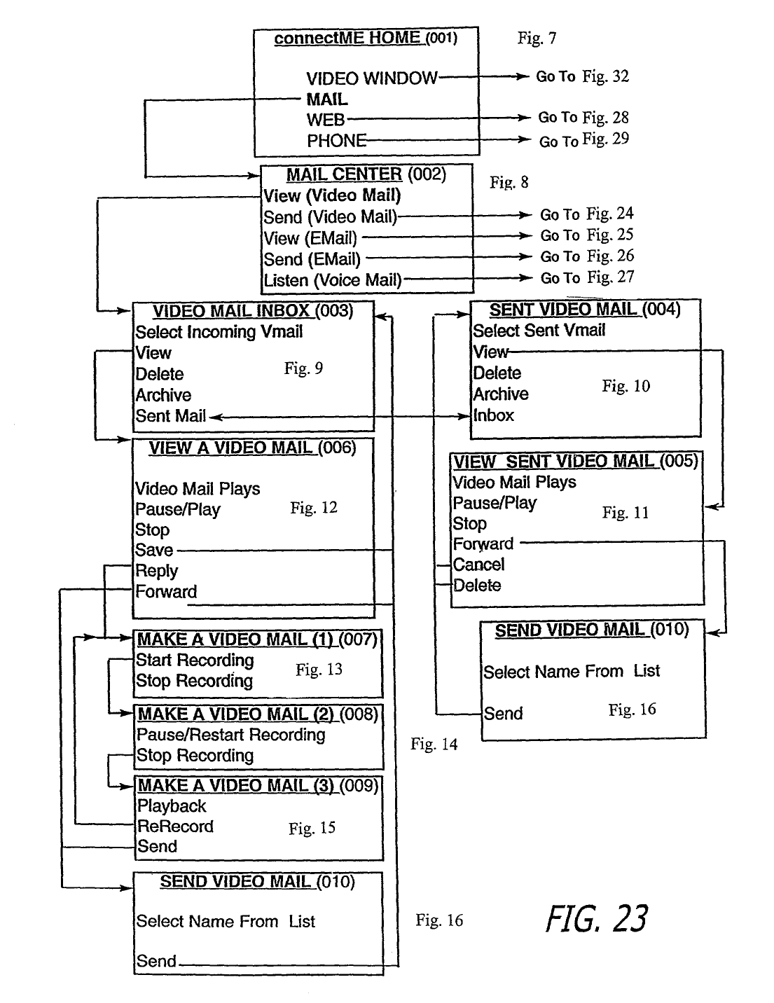

Table B lists the connectME^{SM} navigation flowcharts and correlates Drawing Figures and their prime functions for FIGS. 22-34.

TABLE B

| FIGURE | |
|---|---|
| NO. | TITLE |
| 22 | MAIL CENTER/HOME SCREEN |
| 23 | MAIL CENTER/VIEW VIDEO MAIL |
| 24 | MAIL CENTER/SEND VIDEO MAIL |
| 25 | MAIL CENTER/READ E-MAIL |
| 26 | MAIL CENTER/SEND E-MAIL |
| 27 | MAIL CENTER/LISTEN TO VOICE MAIL |
| 28 | WEB CENTER |
| 29 | PHONE CENTER/VIDEO PHONE CALL |
| 30 | PHONE CENTER/VOICE PHONE CALL |
| 31 | PHONE CENTER/TELEPHONE |
| 32 | VIDEO WINDOW |
| 33 | CONNECTME HELP |
| 34 | INCOMING CALLS |

Referring now more particularly to FIGS. 1, 2, 5 and 7-34 of the drawings, there are shown typical navigational sequence screens, as further amplified by the ensuing description of typical tasks.

To Make A Video Mail

To make a video mail, connectME^{SM} service is first selected by pressing the cME button on the remote control unit 100 (FIGS. 5 and 7). The connectME^{SM} HOME screen then appears.

connectME^{SM}HOME Screen #001 (FIG. 7)

The connectME^{SM} screen has four selections:

1. MAIL

2. WEB

3. PHONE

4. A VIDEO WINDOW which displays video content such as weather, news or a community calendar.

The MAIL selection is visually highlighted when the HOME screen is first selected.

If another selection is desired, repeatedly pushing or continuously pushing down the NEXT button on the remote control will highlight each selection in order: MAIL, WEB, PHONE, VIDEO WINDOW, and then return to the first selection; MAIL and will continue to repeat the same sequence. When the desired selection has been highlighted, pushing GO button on the remote control activates that selection and causes its operating screen to appear. The same two button navigation system (NEXT and GO) is used to access selections in all screens.

To make a video mail, pushing the GO button on the remote control when the MAIL selection is highlighted causes the MAIL CENTER screen to appear.

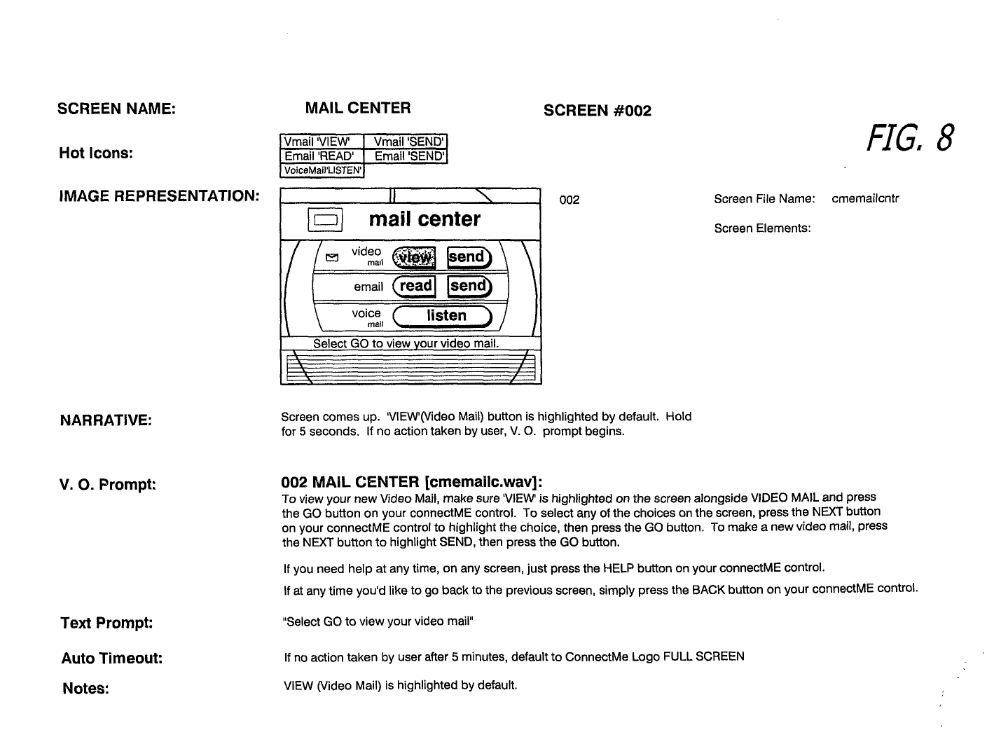

MAIL CENTER Screen #002 (FIG. 8)

The MAIL CENTER screen has five selections:

1. VIEW (Video Mail)

2. SEND (Video Mail)

3. READ (E-mail)

4. SEND (E-mail)

5. LISTEN (Voice Mail)

The VIEW (Video Mail) selection is highlighted when the MAIL CENTER screen is first selected.

If another selection is desired, repeatedly pushing or continuously pushing down the NEXT button on the remote control will highlight each selection in order, VIEW (Video Mail), SEND (Video Mail), READ (E-mail), SEND (E-mail), LISTEN (Voice Mail) and then return to the first selection: VIEW (Video Mail) and will continue to repeat the same sequence. When the desired selection has been highlighted, pushing the GO button on the remote control activates that selection and its operating screen appears.

To make a video mail, pushing the GO button on the remote control when the SEND (Video Mail) button is highlighted causes the MAKE VIDEO MAIL #1 screen to appear.

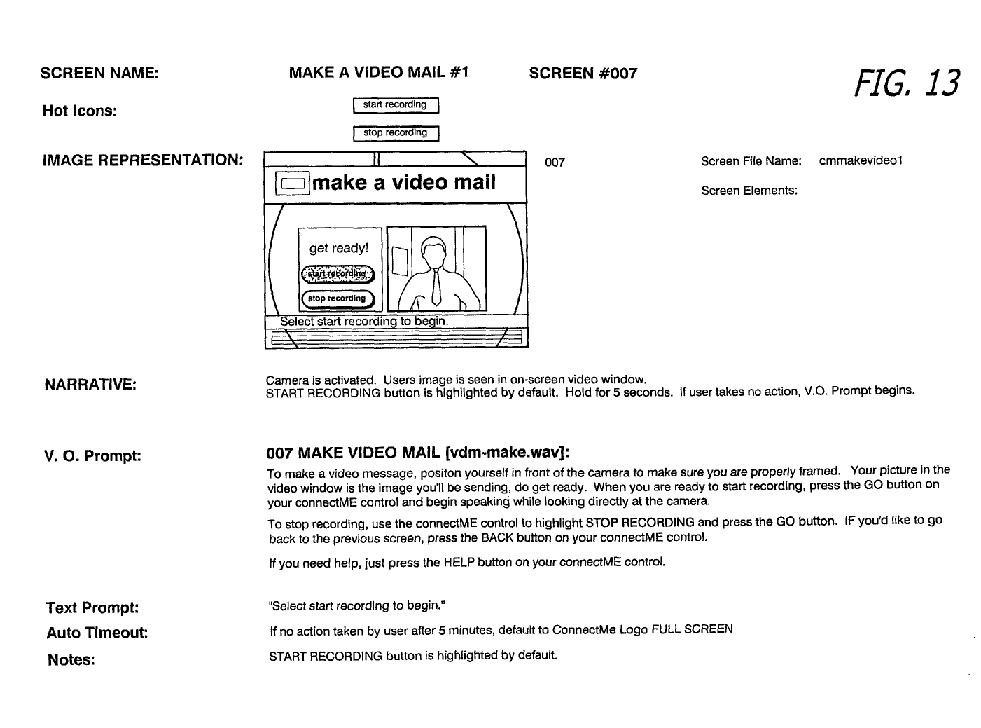

MAKE A VIDEO MAIL #1 Screen (FIG. 13)

The MAKE A VIDEO MAIL #1 screen has two selections:

1. START RECORDING

2. Stop recording

The START RECORDING selection is highlighted when the MAKE A VIDEO MAIL #1 screen is first selected. Pushing the GO button on the remote control when the start recording button is highlighted causes the camera to START RECORDING and the MAKE A VIDEO Mail #2 screen to appear.

If another selection is desired, repeatedly pushing or continuously pushing down the NEXT button on the remote control will highlight each selection in order, START RECORDING, STOP RECORDING, and then return to the first selection: START RECORDING, and will continue to repeat the same sequence.

Pushing the GO button on the remote control when the STOP RECORDING selection is highlighted stops the recording and causes the MAKE A VIDEO MAIL #3 screen to appear.

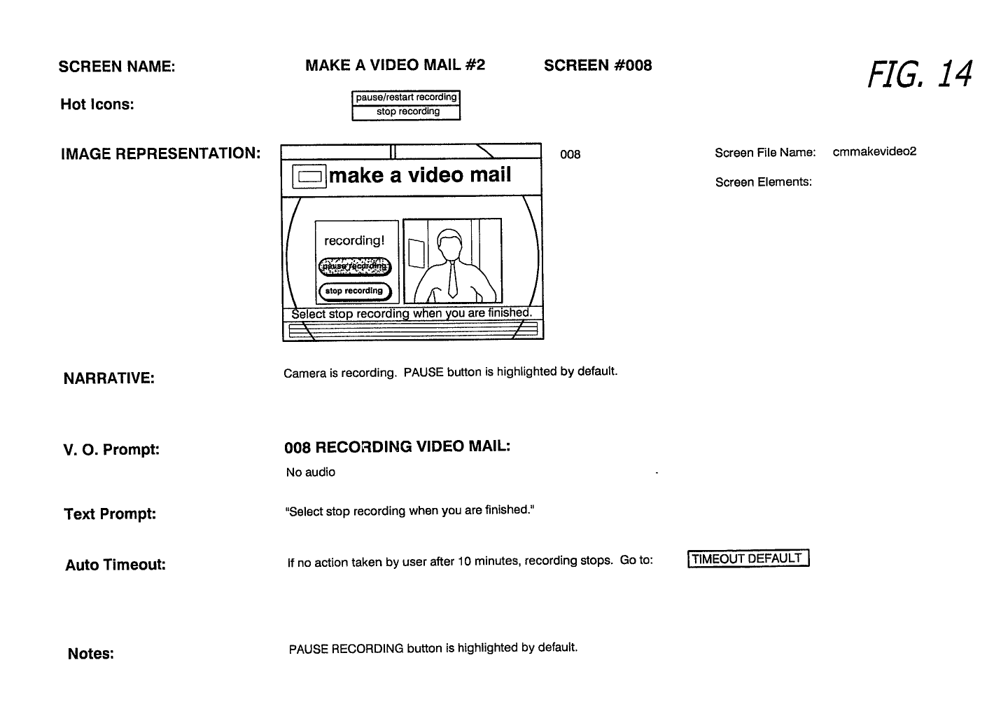

MAKE A VIDEO MAIL #2 Screen #008 (FIG. 14)

The MAKE A VIDEO MAIL #2 screen has two selections:

1. Pause RECORDING

2. STOP RECORDING

The PAUSE RECORDING selection is highlighted and the camera is recording when the MAKE A VIDEO MAIL #2 screen is first selected.

If another selection is desired, pushing the NEXT button on the remote control highlights each selection in order: PAUSE RECORDING, STOP RECORDING, and then returns to the first selection, PAUSE RECORDING and continues to repeat the same sequence.

Pushing the GO button on the remote control when the PAUSE RECORDING selection is highlighted paused the recording and causes the PAUSE RECORDING button to change to a highlighted RESTART RECORDING selection. Pushing the GO button on the remote control when the RESTART RECORDING selection is highlighted restarts the recording and causes the RESTART RECORDING selection to change back to a highlighted PAUSE RECORDING selection. Pushing the GO button on the remote control when the STOP RECORDING selection is highlighted stops the recording and causes the MAKE A VIDEO MAIL #3 screen to appear.

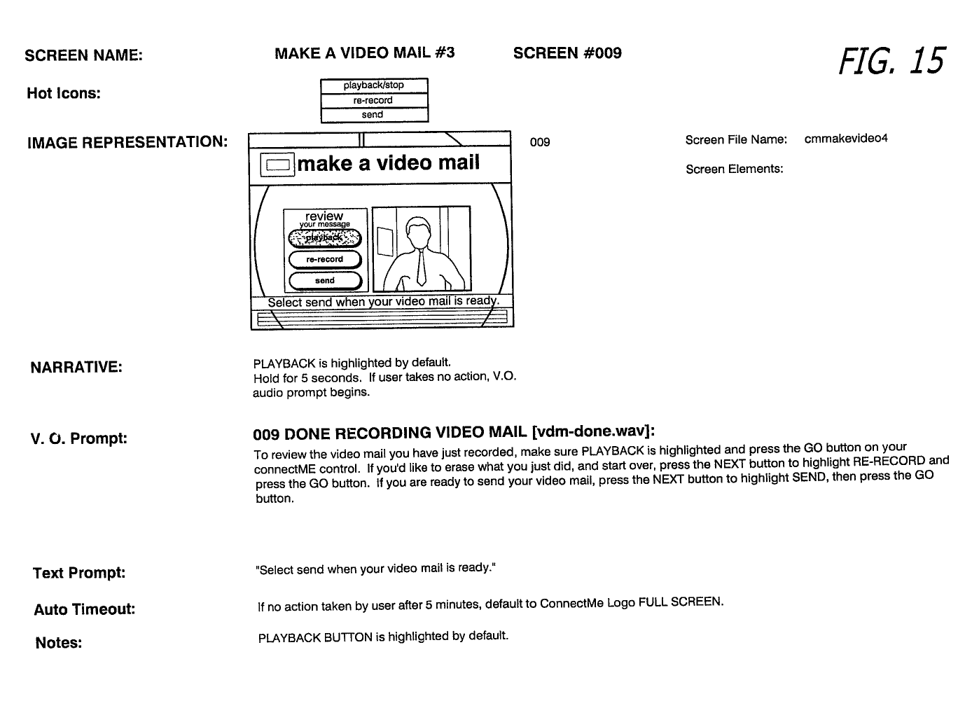

MAKE A VIDEO MAIL #3 Screen #009 (FIG. 15)

The MAKE A VIDEO MAIL #3 screen has three selections:

1. PLAYBACK

2. RERECORD

3. SEND

The PLAYBACK selection is highlighted when the MAKE A VIDEO MAIL #3 screen is first selected.

If another selection is desired, pushing the NEXT button on the remote control highlights each selection in order: PLAYBACK, RERECORD, SEND, and then returns to the first selection, PLAYBACK and continues to repeat the same sequence.

Pushing the GO button on the remote control when the PLAYBACK selection is highlighted causes the video mail that was just recorded to play back on screen. Pushing the GO button on the remote control when the RERECORD selection is highlighted causes the MAKE A VIDEO MAIL #1 screen to reappear. Pushing the GO button on the remote control when the send selection is highlighted causes the SEND VIDEO MAIL screen to appear.

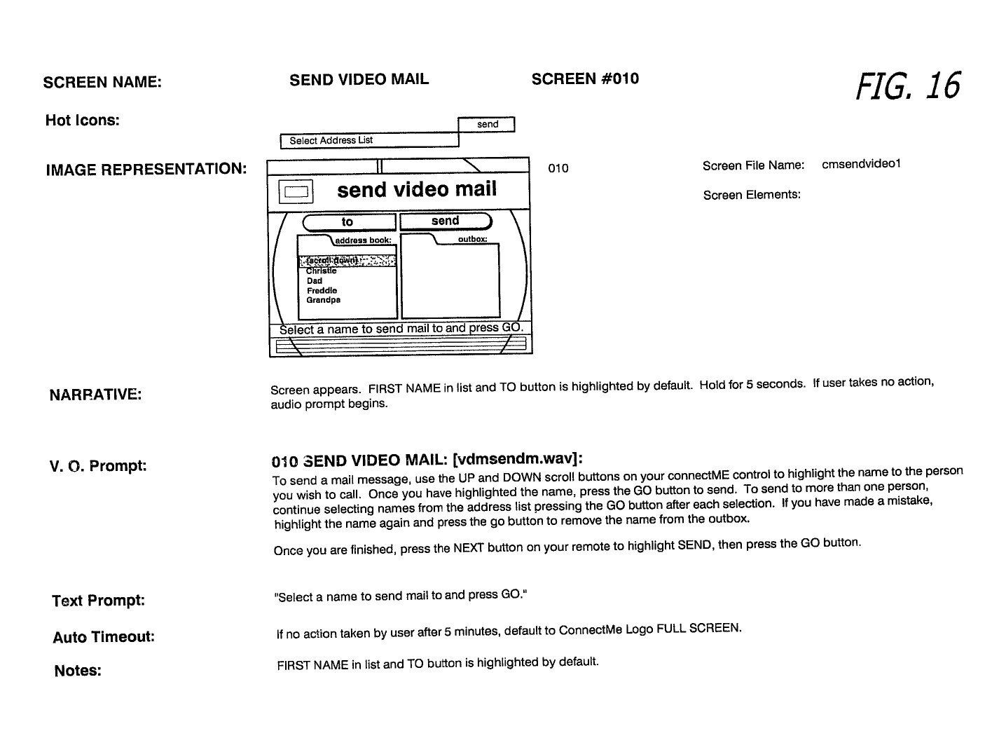

SEND VIDEO MAIL Screen #010 (FIG. 16)

The SEND VIDEO MAIL screen has two selections:

1. TO, including a column titled ADDRESS BOOK, which displays a list of the names in the user's address book in alphabetical order and

2. SEND.

The TO selection and a [SCROLL DOWN] legend at the top of the ADDRESS BOOK column are highlighted when the SEND VIDEO MAIL screen is first selected.

Pushing DOWN the scroll button on the remote control when the SCROLL DOWN legend is highlighted will highlight the first name in the ADDRESS BOOK column. Repeatedly pushing or continuously pushing down the DOWN scroll button on the remote control highlight each name in the list in descending order, until the last name in the list is highlighted. When the last name in list is highlighted, pushing the UP scroll button on the remote control will highlight the previous name in the list. Repeatedly pushing, or continuously pushing down the UP scroll button on the remote control highlights each name in the list in ascending order, until the first name in the list is highlighted.

If another selection is desired, repeatedly pushing or continuously pushing down the NEXT button on the remote control highlight the other selection: SEND and then return to the first selection, TO and continue to repeat the same sequence.

When the desired name in the ADDRESS BOOK is highlighted, pushing the GO button on the remote control will cause the name to appear in a second column titled OUTBOX and change the appearance of the name in the ADDRESS BOOK. Additional names can be highlighted in the ADDRESS BOOK and transferred to the OUTBOX by pushing the GO button on the remote control, up to a limit of ten names. When the name is highlighted in the ADDRESS BOOK that has already been placed in the OUTBOX, pressing the GO button on the remote control will cause the name to be removed from the OUTBOX.

When the SEND selection is highlighted, pushing the GO button on the remote control sends the video mail to the name(s) in the OUTBOX and causes a MAIL HAS BEEN SENT screen to appear for three seconds. The MAIL CENTER screen then appears.

TO VIEW A VIDEO MAIL

To view a video mail, connectME^{SM} service is first selected by pressing the cME button on the remote control. The connectME^{SM} HOME Screen then appears.

connectME^{SM} HOME Screen #001 (FIG. 7)

The connectME^{SM} HOME screen has four on-screen selections:

1. MAIL

2. WEB

3. PHONE

4. A VIDEO WINDOW which displays video content such as weather, news or a community calendar.

The MAIL selection is visually highlighted when the HOME screen is first selected.

If another selection is desired, repeatedly pushing or continuously pushing down the NEXT button on the remote control will highlight each selection in order: MAIL, WEB, PHONE, VIDEO WINDOW, and then return to the first selection; MAIL and will continue to repeat the same sequence. When the desired selection has been highlighted, pushing GO button on the remote control activates that selection and causes its operating screen to appear. The two button navigation system (NEXT and GO) is used to access selections in all screens.

To view a video mail, pushing the GO button on the remote control when the MAIL selection is highlighted causes the MAIL CENTER Screen to appear.

MAIL CENTER Screen #002 (FIG. 8)

The MAIL CENTER screen has five selections:

1. VIEW (Video Mail)

2. SEND (Video Mail)

3. READ (E-mail)

4. SEND (E-mail)

5. LISTEN (Voice Mail)

The VIEW (Video Mail) selection is highlighted when the MAIL CENTER screen is first selected.

If another selection is desired, repeatedly pushing or continuously pushing down the NEXT button on the remote control will highlight each selection in order, VIEW (Video Mail), SEND (Video Mail), READ(E-mail), SEND (E-mail), LISTEN (Voice Mail) and then return to the first selection; VIEW (Video Mail) and will continue to repeat the same sequence. When the desired selection has been highlighted, pushing the GO button on the remote control activates that selection and its operating screen appears.

To view a video mail, pushing the GO button on the remote control when the VIEW (Video Mail) button is highlighted causes the VIDEO MAIL INBOX screen to appear.

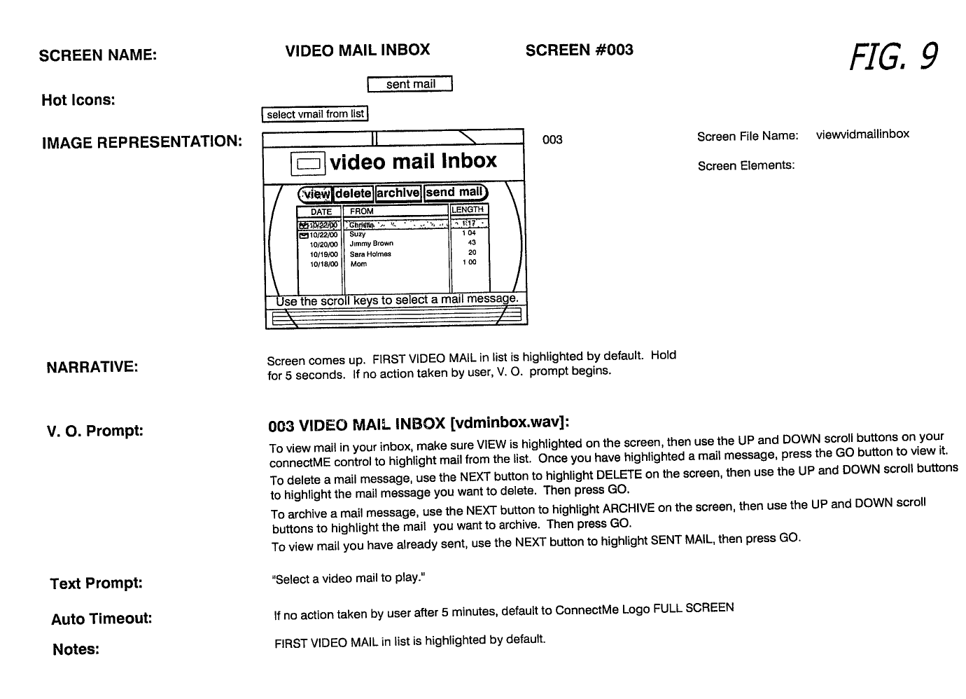

VIDEO MAIL INBOX Screen #003 (FIG. 9)

The VIDEO MAIL INBOX screen has four on-screen selections:

1. VIEW and a VIDEO MAIL INBOX column, which displays a list of video mail

2. DELETE

3. ARCHIVE

4. SENT MAIL

VIEW and the first video mail in the VIDEO MAIL INBOX column is highlighted when the VIDEO MAIL INBOX screen is first selected.

Pushing the DOWN scroll button on the remote control will highlight the next video mail in the VIDEO MAIL INBOX column. Repeatedly pushing or continuously pushing down the DOWN scroll button on the remote control highlights each video mail in the list in descending order, until the last video mail in the list is highlighted. When the last video mail in the list is highlighted, pushing the UP scroll button on the remote control will highlight the previous video mail in the list. Repeatedly pushing, or continuously pushing the UP scroll button on the remote control highlights each video mail in the list in ascending order, until the first name in the list is highlighted.

If another selection is desired, repeatedly pushing or continuously pushing NEXT button on the remote control highlights the other selections in order: VIEW and first video mail in the VIDEO MAIL INBOX, DELETE, ARCHIVE, SENT MAIL, and then returns to the first selection, VIEW and first video mail in the VIDEO MAIL INBOX and continues to repeat the same sequence.

When the VIEW button and the desired video mail in the VIDEO MAIL INBOX column is highlighted, pressing the GO button on the remote control causes the VIEW A VIDEO MAIL screen to appear. When the DELETE button is highlighted, pressing the GO button on the remote control causes a MAIL HAS BEEN DELETED confirmation screen to appear for three seconds. After three seconds, the VIDEO MAIL INBOX screen reappears. When the ARCHIVE button is highlighted, pressing the GO button on the remote control causes a MAIL HAS BEEN ARCHIVED confirmation screen to appear for three seconds. After three seconds, the VIDEO MAIL INBOX screen reappears. When the SENT MAIL button is highlighted, pressing the GO button on the remote control causes the SENT VIDEO MAIL screen to appear.

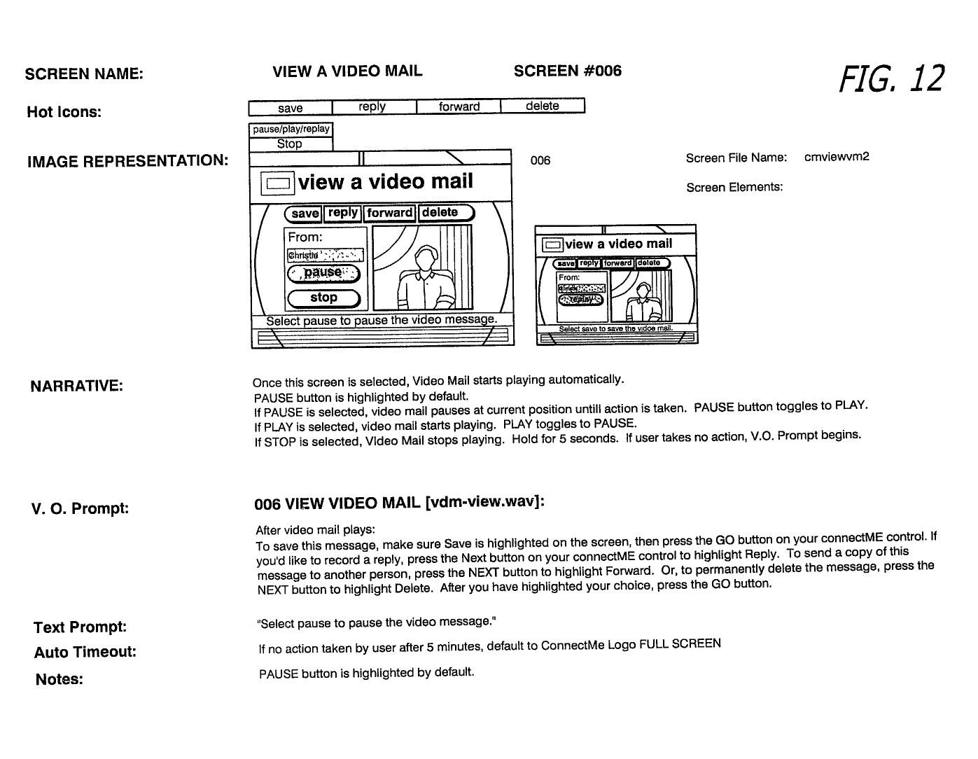

VIEW A VIDEO MAIL Screen #006 (FIG. 12)

The VIEW A VIDEO MAIL screen has six selections:

1. PAUSE

2. STOP

3. SAVE

4. REPLY

5. FORWARD

6. DELETE

The PAUSE button is highlighted and the selected video mail is playing when the VIEW INCOMING VIDEO MAIL screen is first selected.

If another selection is desired, repeatedly pushing or continuously pushing the NEXT button on the remote control highlights each selection in order: PAUSE, STOP, SAVE, REPLY, FORWARD, DELETE and then returns to the first selection; PAUSE and continues to repeat the same sequence.

When the PAUSE button is highlighted, pushing the GO button on the remote control pauses the video mail and causes the PAUSE button to change to a highlighted PLAY button. When the PLAY button is highlighted, pushing the GO button on the remote control restarts the video mail and causes the PLAY button to change back to a highlighted PAUSE button. When the STOP button is highlighted, pressing the GO button on the remote control stops the video mail and causes the SAVE button to be highlighted. When the SAVE button is highlighted, pressing the GO button on the remote control causes a MAIL HAS BEEN SAVED confirmation screen to appear for three seconds. After three seconds, the VIDEO MAIL INBOX screen reappears. When the reply button is highlighted, pressing the GO button on the remote control causes the MAKE A VIDEO Mail #1 screen to appear. When the FORWARD button is highlighted, pressing the GO button on the remote control causes the SEND VIDEO MAIL screen to appear. When the DELETE button is highlighted, pressing the GO button on the remote control causes a MAIL HAS BEEN DELETED confirmation screen to appear for three seconds. After three seconds, the VIDEO MAIL INBOX screen reappears.

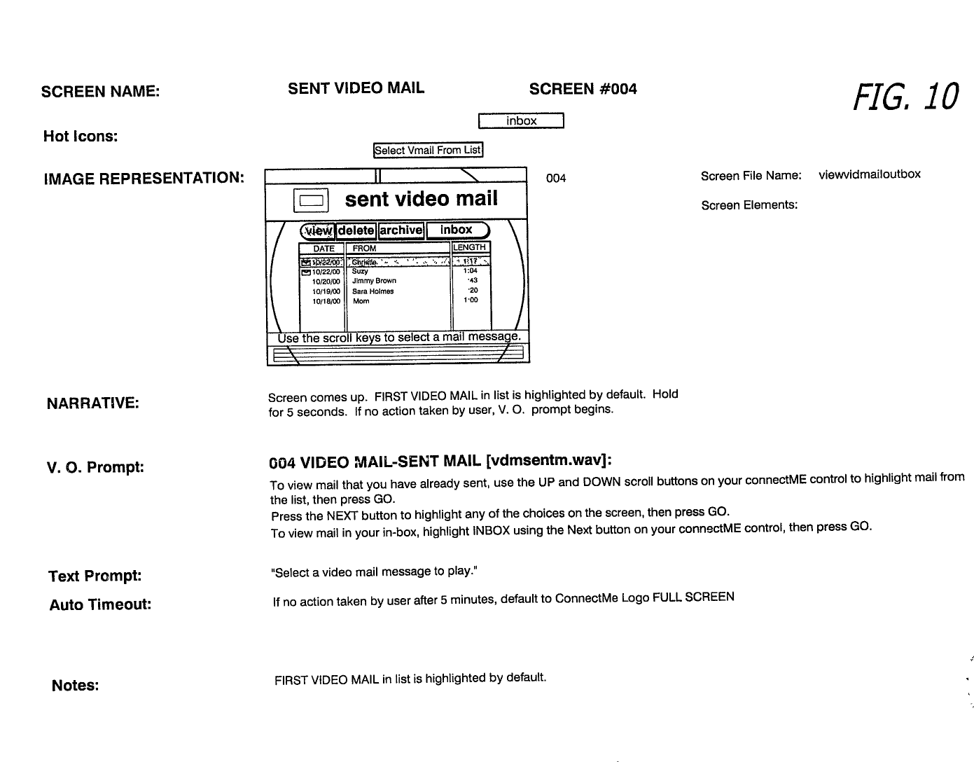

SENT VIDEO MAIL Screen #004 (FIG. 10)

The SENT VIDEO MAIL screen has four on-screen selections:

1. View and an OUTGOING VIDEO MAIL column, which displays a list of sent video mail

2. DELETE

3. ARCHIVE

4. INBOX

VIEW and the first video mail in the OUTGOING VIDEO MAIL column is highlighted when the SENT VIDEO MAIL screen is first selected.

Pushing the DOWN scroll button on the remote control will highlight the next video mail in the OUTGOING VIDEO MAIL column. Repeatedly pushing or continuously pushing DOWN scroll button on the remote control highlights each video mail in the list in descending order, until the last video mail in the list is highlighted. When the last video mail in the list is highlighted, pushing the UP scroll button on the remote control will highlight the previous video mail in the list. Repeatedly pushing, or continuously pushing down the UP scroll button on the remote control highlights each video mail in the list in ascending order, until the first name in the list is highlighted.

If another selection is desired, repeatedly pushing or continuously pushing down the NEXT button on the remote control highlights the other selections in order: VIEW and first video mail in the OUTGOING VIDEO MAIL column, DELETE, ARCHIVE, INBOX, and then returns to the first selection; VIEW and first video mail in the OUTGOING VIDEO MAIL column and continues to repeat the same sequence.

When the view button and the desired video mail in the OUTGOING VIDEO MAIL column is highlighted, pressing the GO button on the remote control causes the VIEW SENT VIDEO MAIL screen to appear. When the delete button is highlighted, pressing the GO button on the remote control causes a MAIL HAS BEEN DELETED confirmation screen to appear for three seconds. After three seconds, the SENT VIDEO MAIL screen reappears. When the ARCHIVE button is highlighted, pressing the GO button on the remote control causes a MAIL HAS BEEN ARCHIVED confirmation screen to appear for three seconds. After three seconds, the SENT VIDEO MAIL screen reappears. When the INBOX button is highlighted, pressing the GO button on the remote control causes the VIDEO MAIL INBOX screen to appear.

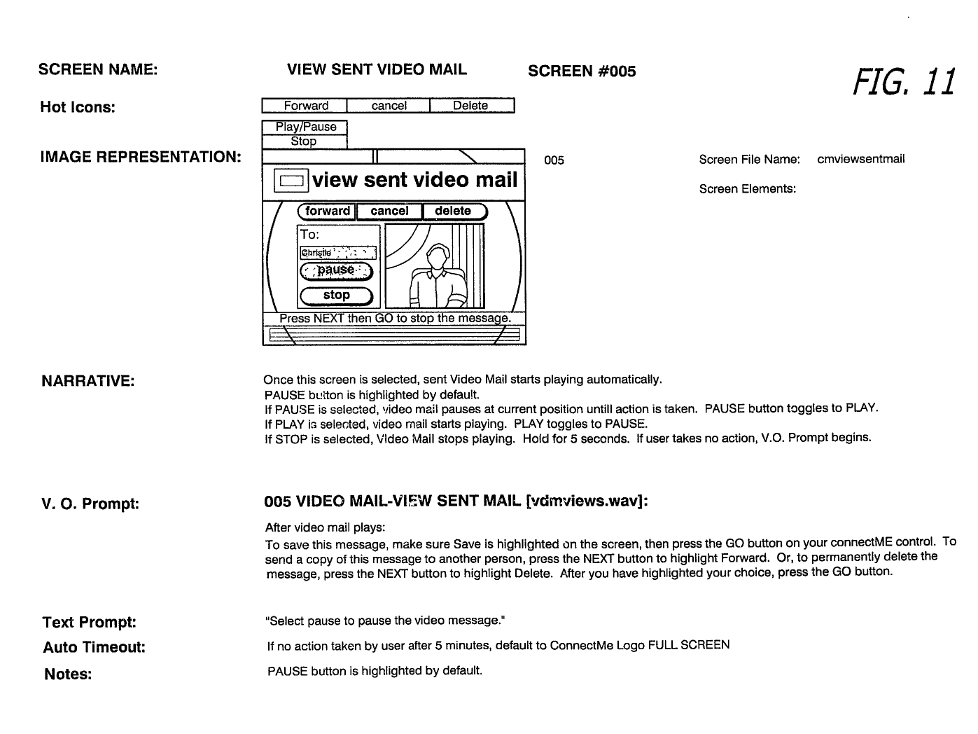

VIEW SENT VIDEO MAIL Screen #005 (FIG. 11)

The VIEW SENT VIDEO MAIL screen has five on-screen selections:

1. PAUSE

2. STOP

3. FORWARD

4. CANCEL

5. DELETE

The PAUSE selection is highlighted and the selected video mail is playing when the VIEW SENT VIDEO MAIL screen is first selected.

If another selection is desired, repeatedly pushing or continuously pushing down the NEXT button on the remote control highlights each selection in order: PAUSE, STOP, FORWARD, CANCEL, DELETE, and then returns to the first selection; PAUSE and continues to repeat the same sequence.

When the PAUSE selection is highlighted, pushing the GO button on the remote control causes the PAUSE button to change to a highlighted PLAY button. When the PLAY button is highlighted, pressing the GO button on the remote control restarts the video mail and causes the PLAY button to change back to a highlighted PAUSE button. When the STOP button is highlighted, pressing the GO button on the remote control stops the video mail and causes the FORWARD button to be highlighted. When the FORWARD button is highlighted, pressing the GO button on the remote control causes the SEND VIDEO MAIL screen to appear. When the CANCEL button is highlighted, pressing the GO button on the remote control causes the SENT VIDEO MAIL screen to reappear. When the DELETE button is highlighted, pressing the GO button on the remote control causes the MAIL HAS BEEN DELETED confirmation screen to appear for three seconds. After three seconds, the SENT VIDEO MAIL screen to reappears.

As previously stated, humans worldwide have evolved, over millennia, a natural social structure based upon multi-generational family units whose members live in close physical proximity. There are many reasons why this particular structure evolved, including the protection, care giving, close social connection, pooling of talents and sense of purpose it provides for its members. In the last century, the fabric of this social structure has been torn apart by rapid technological advances that have created a “Familial Diaspora” in which different generations of a family typically live far apart and are isolated. This situation has caused a reduction in the quality of life for many people, especially isolated senior family members who no longer can easily and frequently connect with their children. The present invention addresses this situation by providing a low cost, humanly natural, “always present” path for spontaneous visual and auditory “virtual visits” between family members, friends, care givers and their patients, etc. The paradigm for the functioning and functionality of the invention is to use technology to provide, over distance, the closest possible approximation of the natural and spontaneous communication that occurs between people who are together in the same space.

All of the above and other features of the aforedescribed invention are facilitated by appropriate software for providing/enabling the functions in the illustrated and equivalent embodiments to “make it happen” in achieving a new and improved Internet based, two-way, video, voice, text and data communication control and/or monitoring system whereby an environment of total interactive connectivity and comfortable immersion in the outside world is simulated for the user without concomitant need for technical proficiency, and creates an enhanced gestalt for a new and more complex milieu akin to an old and familiar gestalt, but in a simpler, more comfortable milieu of direct interaction, all belying the greater complexity of the new system technology. Programming can be changed in the system by the user via the handset control unit 100 and/or the set-top unit 101 and may also be changed by external sources and information received over the Internet.

It will be apparent from the foregoing that, while particular forms of the invention have been illustrated and described, various modifications can be made without departing from the spirit and scope of the invention. Accordingly, it is not intended that the invention be limited, except as by the appended claims.

What is claimed is:

1. An improved system for creating an enhanced virtual reality environment providing an integrated, universal, communication, monitoring and/or control experience, even for those compromised users typically denied such experience, the system providing newly emergent properties not present in the individual modules of the system, but for the synergy with each other created through the vehicle of the user's mind, the system comprising:
a display subsystem including video and/or audio capability;
an r.f. and/or i.f. wireless link communication subsystem, said subsystem including at least a set-top unit subsystem either integral or non-integral with said display subsystem, and either internal or external to said display subsystem, for communicating and coordinating a plurality of diverse functions with both a user and said display subsystem;
a handset control unit for interactive, bi-directional communication by said user with said set-top subsystem, said control unit having at least simplified controls including a pair of visually and/or physically conspicuous adjacent input areas providing a simplified total control interface for all system functions and adapted for easy, uncomplicated operation by users, including a relatively unskilled, handicapped or other compromised user who may otherwise have difficulty accessing and utilizing such system functions;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology and wherein the greater complexity of the system technology is perceived by the user as greater simplicity.

2. An improved system for creating an enhanced virtual reality environment providing an integrated, universal, communication, control and/or monitoring experience, the system comprising:
a video/audio display;
an r.f. and/or i.f. wireless link communication subsystem, said subsystem including a set-top unit for communicating a plurality of diverse functions and data with a user and said display;
a handset control unit for interactive, bi-directional communication by said user with said set-top unit, said control unit having at least simplified controls including a pair of visually and/or physically conspicuous adjacent input areas providing a total control interface for all system functions and adapted for simplified operation by a relatively unskilled, handicapped or other compromised user;
whereby the greater complexity of the system technology provides an enhanced virtual reality perceived by the user as greater simplicity.

3. A system as recited in any of claims 1 or 2, wherein said system is Internet based.

4. A system as set forth in any of claims 1 or 2, wherein said handset control unit includes a resident computer processing unit.

5. A system as set forth in any of claims 1 or 2, wherein said set-top subsystem includes a computer processing unit.

6. A system as set forth in any of claims 1 or 2, wherein each of said set-top subsystem and said handset control unit includes a computer processing unit.

7. A system for creating an enhanced integrated universal communication experience, comprising:
a video monitor;
a wireless link communication subsystem, said subsystem including a set-top subsystem for communicating a wide variety of functions and/or data sources with a user and said monitor;
a handset control unit for interactive bi-directional communication with said set-top subsystem, said control unit having at least simplified controls with a pair of visually and physically conspicuous adjacent buttons or touch screen areas providing a total control interface for substantially all system functions for simple operation by a user, including users lacking computer skills;
whereby an environment of total interactive connectivity and comfortable immersion in the outside world is simulated for the user without concomitant need for technical proficiency, and providing an enhanced gestalt for is a new and more complex milieu akin to an old and familiar gestalt in a simpler, more comfortable milieu of direct interaction, all belying the greater complexity of the new system technology.

8. An improved system for creating an enhanced virtual reality environment providing an integrated, universal, communication and/or control experience, the system comprising:
information means including a video display subsystem and/or audio subsystem, a telephone service and an Internet source;
a wireless link communication subsystem, said subsystem including a set-top subsystem for communicating all functions with both a user and said display subsystem and/or audio subsystem;
a handset control unit subsystem for interactive, bi-directional communication by said user with said set-top subsystem, said control unit having at least simplified controls including a pair of visually and/or physically conspicuous adjacent input areas providing a total control interface for all primary system functions and adapted for simplified operation by a relatively unskilled, handicapped or other compromised user, including users lacking computer skills.

9. An improved system for creating an enhanced virtual reality environment providing an integrated, universal, communication, control and/or monitoring experience, the system comprising:
an Internet source;
means including a video display and/or audio unit;
a wireless link communication subsystem, said subsystem including a set-top unit for communicating and coordinating all functions and data with a user and said display and/or audio unit and said Internet source;
a handset control unit subsystem for interactive, bi-directional communication by said user with said set-top unit, said control unit having at least simplified controls including a pair of visually and/or physically conspicuous adjacent input areas providing a total control interface for all primary system functions and adapted for simplified operation by a relatively unskilled, handicapped or other compromised user, including users lacking computer skills;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction all belying the greater complexity of the new system technology.

10. A system as set forth in any of claims 7, 8 or 9 wherein said handset control unit subsystem includes a resident computer processing unit.

11. A system as set forth in any of claims 7, 8 or 9 wherein said set-top unit subsystem includes a computer processing unit.

12. A system as set forth in any of claims 7, 8 or 9 wherein each of said set-top unit subsystem and said handset control unit subsystem includes a computer processing unit.

13. For use in an improved system for creating an enhanced virtual reality environment providing an integrated, universal, communication, monitoring and/or control experience, a handset control subsystem, comprising:
a handset control unit for interactive, bi-directional communication by a user, said control unit having at least simplified controls including a pair of visually and/or physically conspicuous adjacent input areas providing a total control interface for all system functions and adapted for simplified operation by a relatively unskilled, handicapped or other compromised user, including those users lacking computer skills.

14. In a system for providing an old and comfortable gestalt familiar to a user in a simple environment substantially recreated in a more complex situation or environment through the mind of the user working synergistically in combination with the system, a handset control unit comprising:
a handset control device for interactive, bi-directional communication by a user, said handset control device having at least simplified controls including a pair of visually and/or physically conspicuous adjacent input areas providing a total control interface for all system functions and adapted for simplified operation by a relatively unskilled, handicapped or other compromised user;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction all belying the greater complexity of the new system technology.

15. For use with a system providing a new milieu of more complex possibilities giving rise to a previous familiar and comfortable gestalt, such system including:
a handset control unit for interactive, bi-directional communication by a user with the remainder of the system and other external data sources, said control unit having at least simplified controls including a pair of visually and/or physically conspicuous adjacent input areas providing a total control interface for all system functions and adapted for simplified operation by a relatively unskilled, handicapped or other compromised user including users lacking computer skills;
whereby an environment of total interactive connectivity and comfortable immersion in the outside world is simulated for the user without concomitant need for technical proficiency and the greater complexity of the system technology is perceived by the user as simplicity.

16. An improved system for creating an enhanced virtual reality environment providing an integrated, universal, communication and/or control experience, even for those compromised users typically denied such experience, the system providing newly emergent properties not present in the individual modules of the system, but for the synergy with each other created through the vehicle of the user's mind, a handset control comprising:
a physical until capable of being handheld by a user for interactive, bi-directional communication by the user with a central site, said unit having at least simplified controls including a pair of visually and/or physically conspicuous adjacent input areas providing a total control interface for system functions and adapted for simplified operation by a relatively unskilled, handicapped or other compromised user.

17. In a system for creating an enhanced virtual reality environment providing an integrated/universal/communication and/or control experience for a user, a handset control comprising:
a physical unit having a resident computer capable of being handheld by a user for interactive, bi-directional communication by the user with a central site, said unit having at least simplified controls including a pair of visually and/or physically conspicuous adjacent input areas providing a total control interface for all system functions and adapted for simplified operation by a relatively unskilled, handicapped or other compromised user;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction all belying the greater complexity of the new system technology.

18. A handset control unit as recited in any of claims 13-17, wherein said adjacent input areas include oversized buttons.

19. A handset control unit as recited in any of claims 13-17, wherein said adjacent input areas include touch screen areas.

20. A handset control unit as recited in any of claims 13-17, wherein said adjacent input areas are labeled “NEXT” and “GO”.

21. A handset control unit as recited in any of claims 13-17, wherein said adjacent input areas are labeled “NEXT”, “GO” and/or “CONNECT”.

22. A system for creating an enhanced integrated universal communication experience, comprising:
a graphical display;
a wireless link communication subsystem, said subsystem including a set-top unit subsystem for communicating a wide variety of functions and/or data sources with a user and said display;
a handset control unit for interactive communication with said set-top unit, said control unit having at least simplified controls with a pair of visually and physically conspicuous adjacent buttons providing a total control interface for all system functions for simple operation by a user.

23. A system for creating an enhanced integrated universal communication experience, comprising:
a graphical display;
a wireless link communication subsystem, said subsystem including a set-top unit for communicating a wide variety of functions and/or data sources with a user and said display;
a handset control unit for interactive communication with said set-top unit, said control unit having at least simplified controls with a pair of visually and physically conspicuous adjacent touch screen areas providing a total control interface for all system functions for simple operation by a user.

24. In a system for creating an enhanced virtual reality environment providing an integrated, universal, communication and/or control experience, even for those compromised users typically denied such experience, the system providing newly emergent properties not present in the individual modules of the system, but for the synergy with each other created through the vehicle of the user's mind, the improvement comprising:
a handset control unit for interactive, bi-directional communication by said user with said set-top unit, said control unit having at least simplified controls including a pair of visually and/or physically conspicuous adjacent input areas providing a total control interface for all system functions and adapted for simplified operation by a relatively unskilled, handicapped or other compromised user;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction all belying the greater complexity of the new system technology.

25. A system providing an old and comfortable gestalt familiar to a user in a simple environment substantially recreated in a more complex situation or environment through the mind of the user working synergistically in combination with the system; the system comprising:
means including a video display and/or audio unit subsystem;
a wireless link communication subsystem, said subsystem including a set-top unit subsystem having a central processing unit for communicating all functions with both a user and said display the user employing a simplified handset control easily operated by a user lacking computer skills;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction all belying the greater complexity of the new system technology.

26. In a system for creating an enhanced virtual reality environment providing an integrated/universal/communication and/or control experience, a set-top unit subsystem comprising:
means for on board computer processing and communicating with telephone services, an Internet service, appropriate displays and a user handset subsystem for interactive, bi-directional communication by the user with the set-top unit subsystem, said control unit subsystem having at least simplified controls including a pair of visually and/or physically conspicuous adjacent input areas providing a total control interface for all system functions and adapted for simplified operation by users, including relatively unskilled, handicapped or other compromised users.

27. A system providing new milieu/setting or environment of more complex possibilities giving rise to a previous familiar and comfortable gestalt, such system comprising:
a handset control unit subsystem for interactive, bi-directional communication by a user with a set-top unit subsystem, said control unit subsystem having at least simplified controls including a pair of visually and/or physically conspicuous adjacent input areas providing a total control interface for all system functions and adapted for simplified operation by a relatively unskilled, handicapped or other compromised user;
whereby an environment of total interactive connectivity and comfortable immersion in the outside world is simulated for the user without concomitant need for technical proficiency, and the greater complexity of the system technology is perceived by the user as simplicity.

28. A system as recited in any of claims 1-27, and further including data sources compromising:
a telephone service.

29. A system as recited in any of claims 1-27, including data sources compromising:
a voice over Internet protocol (VOIP) subsystem.

30. A system as recited in any of claims 1-27, including data sources compromising:
a virtual private network (VPN).

31. A system as recited in any of claims 1-27, including data sources compromising:
a public switched telephone network (PSTN).

32. A system as recited in any of claims 1-27, wherein the wireless subsystem further comprises:
a limited range for a specific user which is non-overlapping with the range for any other user.

33. A system as recited in any of claims 1-27, wherein the range of the wireless link is limited so that it provides a zone dedicated to the user and does not overlap/conflict/interfere with the zone of any other user.

34. A system as recited in any of claims 1-27, wherein the wireless link range is ½ mile or less.

35. A system as recited in any of claims 1-27, wherein the wireless link range is approximately ½ mile.

36. A system as set forth in any of claims 1-27, wherein said handset control unit further comprises:
a microphone and/or loudspeaker on the handset unit.

37. A system as set forth in any of claims 1-27, wherein said handset control unit further comprises:
a vibrator to alert the user.

38. A system as set forth in any of claims 1-27, wherein said handset control unit further comprises:
function lights on said handset unit for conveying information to the user.

39. A system as set forth in claim 38, wherein said lights are capable of flashing.

40. A system as set forth in any of claims 1-27, wherein said handset control unit further comprises:
a graphical display on said handset unit.

41. A system as recited in any of claims 1-27, wherein said handset adjacent input areas include:
a pair of oversized buttons.

42. A system as recited in any of claims 1-27, wherein said handset adjacent input areas further include:
a pair of touch screen contact areas.

43. A system as recited in any of claims 1-27, wherein said handset further comprises:
a microphone/speaker system.

44. A handset control unit as set forth in any of claims 1-27 wherein said conspicuous input areas include:
oversize buttons or touch screen areas.

45. A system as set forth in any of claims 1-27, and further comprising:
means for dynamically reprogramming said set-top unit.

46. A system as set forth in any of claims 1-27, and further including:
means for dynamically reprogramming said handset.

47. A system as set forth in any of claims 1-27, and further including:
means for dynamically reprogramming either said handset, said set-top unit, or both.

48. A system as recited in any of claims 45-47, wherein said reprogramming can be accomplished by said user.

49. A system as recited in any of claims 45-47, wherein said reprogramming can be accomplished by a source external to said user.

50. A system as recited in any of claims 45-47, wherein said reprogramming can be accomplished by a remote source external to said system.

51. A system providing for a user an intuitive cyber-like zone or self-sufficient cocoon environment creating a virtual natural experience facilitating maximized functional communication, control and/or monitoring with utmost intuitive simplicity, comfort and convenience to the user, such system comprising:
a telephone service;
an Internet display;
a video/audio display;
a wireless link communication subsystem, said subsystem including a set-top unit subsystem for communicating a plurality of diverse functions with both a user said display and said Internet/telephone services;
a handset control unit for interactive, bi-directional communication by said user with said set-top unit subsystem, said control unit including simplified controls having a pair of visually and/or physically conspicuous adjacent input areas providing a control interface for system functions and adapted for simplified operation by a relatively unskilled, handicapped or other compromised user, including users lacking computer skills;
whereby the greater complexity of the system technology provides an enhanced virtual reality perceived by the user as greater simplicity.

52. A system providing newly emergent properties not present in the individual modules, but for the synergy with each other created through the vehicle of the user's mind, the system comprising:
an Internet service;
a video/audio display;
a telephone service;
a wireless link communication subsystem, said subsystem including a set-top unit for communicating a plurality of diverse functions with both a user, said display and said Internet/telephone services;
a handset control unit for interactive, bi-directional communication by said user with said set-top unit, said control unit having at least simplified controls including a pair of visually and/or physically conspicuous adjacent input areas providing a total control interface for all system functions and adapted for simplified operation by a relatively unskilled, handicapped or other compromised user;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology and wherein the greater complexity of the system technology is perceived by the user as greater simplicity.

53. A system as set forth in either of claims 51 or 52, wherein said Internet provides Internet browsing.

54. A system as set forth in any of claims 51-53, wherein said handset unit is capable of making voice telephone calls.

55. A system as set forth in any of claims 51 or 52, wherein said handset unit is capable of making voice telephone calls using PSTN lines.

56. A system as set forth in any of claims 51 or 52, wherein said handset unit is capable of making voice telephone calls using VOIP services.

57. A system as set forth in any of claims 51 or 52, wherein said handset unit is capable of making voice telephone calls using a VPN.

58. A system as set forth in any of claims 51 or 57, wherein said handset unit has PSTN, VOIP and/or VPN available simultaneously.

59. A system as set forth in any of claims 51-57, wherein wireless switching is accomplished automatically in said communication subsystem to normal telephone service when beyond the range of the wireless link zone.

60. A system as set forth in any of claims 51-59, wherein the system also controls audio/video recording.

61. A system as set forth in any of claims 51 or 52, wherein a handset unit is worn by a user for monitoring physiological data.

62. A system as set forth in any of claims 1-23, 52-57 and further including GUI software for enabling the handset control, set-top box subsystem and other system components to create an environment of total interactive connectivity and comfortable immersion in the outside world which is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology.

63. A system as set forth in any of claims 1-62, and further including means providing an external video camera that connects to the set-top box to provide the video image of the caller during video phone and video mail use.

64. A system as set forth in any of claims 1-62, and further including means providing an RF data and audio transceiver, antenna, video camera, and digital video encoder contained within a single compact housing with a digital data I/O connection to carry combined video, audio and control data to and from an external set-top box or PC, and which may optionally contain a microphone and digital audio encoder, whereby the connectME^{SM} service may be operated using a set-top boxes and PCs not specifically equipped to support connectMe^{SM} service.

65. A system as set forth in any of claims 1-62, and further including means providing a speakerphone function for hands free audio transmission and reception, out of camera range, during videophone use.

66. A method for creating an enhanced virtual reality environment providing an integrated, universal, communication and/or control experience, comprising the steps of:
displaying video/audio;
providing a connection to an Internet service;
communicating by an r.f. and/or i.f. wireless link, between a user handset and a set-top unit for controlling a plurality of diverse functions and data flow involving a user handset unit, the display and/or the Internet;
the handset control unit providing for interactive, bi-directional communication by the user with the set-top unit, the control unit providing at least simplified controls including a pair of visually and/or physically conspicuous adjacent input areas providing a total control interface for system functions and adapted for simplified operation by a relatively unskilled, handicapped or other compromised user;
whereby an environment of total interactive connectivity and comfortable immersion in the outside world is simulated for the user without concomitant need for technical proficiency.

67. A method for creating an enhanced integrated universal communication control/monitoring experience, comprising the steps of:
providing a display;
communicating between a user handset and a set-top unit which communicates a wide variety of functions and/or data sources with a user and the display;
the handset control unit providing for interactive bi-directional communication with said set-top unit, the control unit having at least simplified controls with a pair of visually and physically conspicuous adjacent buttons or touch screen areas providing a total control interface for substantially all system functions for simple operation by a user, including users lacking computer skills.

68. A method for creating an enhanced virtual reality environment providing an integrated/universal/communication, monitoring and/or control experience, comprising the steps of:
providing a handset control unit for interactive, bi-directional communication by a user, said control unit having at least simplified controls including a pair of visually and/or physically conspicuous adjacent input areas providing a total control interface for all system functions and adapted for simplified operation by a relatively unskilled, handicapped or other compromised user, including users lacking computer skills;
whereby an environment of total interactive connectivity and comfortable immersion in the outside world is simulated for the user without concomitant need for technical proficiency.

69. A method for creating an enhanced virtual reality environment providing an integrated/universal/communication and/or control experience for a user, comprising the steps of:
providing a physical unit capable of being handheld by a user for communication by the user with a central site, the unit having at least simplified controls including a pair of visually and/or physically conspicuous adjacent input areas providing a total control interface for all system functions and adapted for simplified operation by a relatively unskilled, handicapped or other compromised user;
whereby an environment of total interactive connectivity and comfortable immersion in the outside world is simulated for the user without concomitant need for technical proficiency.

70. A method for creating an enhanced integrated universal communication experience, comprising the steps of:
providing a video monitor capable of video/audio output display;
providing a wireless link communication subsystem, said subsystem including a set-top unit subsystem for communicating a wide variety of functions and/or data sources with a user and the monitor;
providing handset control subsystem for interactive communication with the set-top unit subsystem, the handset control having at least simplified controls with a pair of visually and physically conspicuous adjacent buttons/touch screen areas providing a total control interface for system functions and involving only simple operation by a user;
whereby an environment of total interactive connectivity and comfortable immersion in the outside world is simulated for the user without concomitant need for technical proficiency.

71. A new and improved method for creating an enhanced virtual reality environment providing an integrated/universal/communication, monitoring and/or control experience, the method comprising the steps of:
providing a video display and/or audio unit;
providing a wireless link communication subsystem, including a set-top unit for communicating all functions with a user and the display;
whereby an environment of total interactive connectivity and comfortable immersion in the outside world is simulated for the user without concomitant need for technical proficiency.

72. A method for creating an enhanced virtual reality environment providing an integrated/universal/communication and/or control experience, comprising the steps of:
providing a set-top unit in bidirectional communication with the Internet/telephone/monitoring services;
providing a handset control unit for interactive, bi-directional communication by the user with the set-top unit, the control unit having at least simplified controls including a pair of visually and/or physically conspicuous adjacent input areas providing an interface for system functions and adapted for simplified operation by a relatively unskilled, handicapped or other compromised user;
whereby an environment of total interactive connectivity and comfortable immersion in the outside world is simulated for the user without concomitant need for technical proficiency.

73. A method as recited in any of claims 66-72, and further comprising the steps of:
providing a data source including a telephone service.

74. A method as recited in any of claims 66-72, and further comprising the steps of:
providing a data source including a voice over Internet protocol (VOIP) subsystem.

75. A method as recited in any of claims 66-72, and further comprising the steps of:
providing a data source including a virtual private network (VPN).

76. A method as recited in any of claims 66-72, and further comprising the steps of:
providing a public switched telephone network (PSTN).

77. A method as recited in any of claims 66-72, and further comprising the steps of:
providing a limited range for a specific user which is non-interfering with the range assigned to any other user.

78. A method as set forth in any of claims 66-77, further comprising the steps of:
providing a vibrator with the handset unit to selectively alert the user.

79. A method as set forth in any of claims 66-78, and further comprising the steps of:
providing function lights on the handset unit for conveying information to the user.

80. A method as set forth in claim 79, wherein the lights are capable of flashing.

81. A method as set forth in any of claims 66-80, and further comprising the steps of:
graphically displaying information on the handset unit.

82. A method as recited in any of claims 66-81, including the steps of:
providing a pair of oversized buttons for the handset adjacent input areas.

83. A method as recited in any of claims 66-82, and further including the steps of:
providing a pair of touch screen contact areas for the handset adjacent input areas.

84. A method as recited in any of claims 66-83, and further comprising the steps of:
providing a microphone/speaker system on the handset unit.

85. A method as recited in any of claims 66-84, wherein one of said pair of buttons is for a “NEXT” function and the other button is for a “GO” function.

86. A method as set forth in any of claims 66-85, and further comprising the steps of:
dynamically reprogramming said set-top unit.

87. A method as set forth in any of claims 66-86, and further including the steps of:
dynamically reprogramming the handset control unit.

88. A method as set forth in any of claims 66-87, and further including the steps of:
dynamically reprogramming either the handset, the set-top unit, or both.

89. A method as recited in any of claims 86-88, wherein said reprogramming can be accomplished by said user.

90. A method as recited in any of claims 86-88, wherein said reprogramming can be accomplished by a source external to said user.

91. A method as recited in any of claims 86-88, wherein said reprogramming can be accomplished by a remote source external to said system.

92. A method providing for a user an intuitive, self-sufficient environment creating a virtual natural experience facilitating maximized functional communication, control and/or monitoring with simplicity, comfort and convenience to the user, comprising the steps of:
providing a simplified handset unit having interactive, bi-directional communication by the user with the set-top unit, the control unit providing at least simplified controls including a pair of visually and/or physically conspicuous adjacent input areas providing a control interface for system functions and adapted for simplified operation by a relatively unskilled, handicapped or other compromised user;
providing a set-top unit having interactive, bi-directional communication by the user with the set-top unit, the control unit providing at least simplified controls including a pair of visually and/or physically conspicuous adjacent input areas providing a control interface for system functions and adapted for simplified operation by a relatively unskilled, handicapped or other compromised user; and
providing a bidirectional wireless link between said set-top unit and said handset unit; and
providing software means for enabling the handset, set-top box and other system components to create an environment of total interactive connectivity and comfortable immersion in the outside world which is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology;
whereby an environment of total interactive connectivity and comfortable immersion in the outside world is simulated for the user without concomitant need for technical proficiency.

93. A method as recited in any of claims 66-92, further comprising the steps of:
limiting the range of the wireless link so that it provides a zone dedicated to the user and does not overlap/conflict/interfere with the zone of any other user.

94. A method as recited in any of claims 66-93, wherein, the wireless link range is ½ mile or less.

95. A method as recited in any of claims 66-93, wherein, the wireless link range is approximately ½ mile.

96. A method providing new milieu or setting or environment of more complex possibilities giving rise to a previous familiar and comfortable gestalt, such method comprising the steps of:
displaying video/audio;
communicating by an r.f. and/or i.f. wireless link, between a user handset and a set-top unit for controlling a plurality of diverse functions and data flow involving both the user handset and the display;
the handset control unit providing for interactive, bi-directional communication by the user with the set-top unit, the control unit providing at least simplified controls including a pair of visually and/or physically conspicuous adjacent input areas providing a total control interface for system functions and adapted for simplified operation by a relatively unskilled, handicapped or other compromised user;
whereby an environment of total interactive connectivity and comfortable immersion in the outside world is simulated for the user without concomitant need for technical proficiency and the greater complexity of the system technology is perceived by the user as greater simplicity.

97. A method providing newly emergent properties not present in the individual modules of a system, but for the synergy with each other created through the vehicle of the user's mind, comprising the steps of:
providing a telephone service;
providing an Internet service;
displaying video/audio;
communicating by a wireless link, between a user handset and a set-top unit for controlling a plurality of diverse functions and data flow involving the user handset, the display and/or the telephone/Internet services;
the handset control unit providing for interactive, bi-directional communication by the user with the set-top unit, the control unit providing at least simplified controls including a pair of visually and/or physically conspicuous adjacent input areas providing an control interface for system functions and adapted for simplified operation by a relatively unskilled, handicapped or other compromised user;
whereby an environment of total interactive connectivity and comfortable immersion in the outside world is simulated for the user without concomitant need for technical proficiency, the greater complexity of the system technology being perceived by the user as simplicity.

98. A method as set forth in any of claims 66-97, further comprising steps of:
providing voice control for the user.

99. A method as set forth in any of claims 66-98, further comprising the steps of:
providing voice command facilities in the handset unit.

100. A method as set forth in any of claims 66-99, wherein the system is Internet based and provides voice facilities.

101. A method as set forth in any of claims 66-100, wherein the system is Internet based and provides text.

102. A method as set forth in any of claims 66-101, wherein the system is Internet based and provides data.

103. A method as set forth in any of claims 66-102, wherein the system is Internet based and provides video mail.

104. A method as set forth in any of claims 66-103, wherein the system is Internet based and provides video telephone.

105. A method as set forth in any of claims 66-104, wherein the system is Internet based and provides e-mail.

106. A method as set forth in any of claims 66-105, wherein the system is Internet based and provides Internet browsing.

107. A method as set forth in any of claims 66-106, wherein the handset unit is capable of making voice telephone calls.

108. A method as set forth in any of claims 66-107, wherein the handset unit is capable of making voice telephone calls using PSTN lines.

109. A method as set forth in any of claims 66-108, wherein the handset unit is capable of making voice telephone calls using VOIP technology.

110. A method as set forth in any of claims 66-109, wherein the handset unit is capable of making voice telephone calls using VPN technology.

111. A method as set forth in any of claims 66-110, wherein the handset unit has PSTN, VOIP and/or VPN available simultaneously.

112. A method as set forth in any of claims 66-111, wherein the wireless link switches automatically to normal telephone service when beyond the range of the wireless link zone.

113. A method as set forth in any of claims 66-112, wherein the system also controls audio/video recording.

114. A method as set forth in any of claims 66-113, wherein a handset unit is worn by a user for monitoring physiological data.

115. A method in any of claims 66-114 including the step of providing GUI software for enabling the handset, set-top box and other system components to create an environment of total interactive connectivity and comfortable immersion in the outside world which is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology.

116. A method as set forth in any of claims 66-115 including the step of providing an external video camera that connects to the set-top box to provide the video image of the caller during video phone and video mail use.

117. A method as set forth in any of claims 66-116 including the step of providing an RF data and audio transceiver, antenna, video camera, and digital video encoder contained within a single compact housing with a digital data I/O connection to carry combined video, audio and control data to and from an external set-top box or PC, and which may optionally contain a microphone and digital audio encoder, whereby the connectME^{SM} service may be operated using a set-top boxes and PCs not specifically equipped to support connectMe^{SM} service.

118. A method as set forth in any of claims 66-117 including the step of providing a speakerphone function for hands free audio transmission and reception, out of camera range, during videophone use.

119. For use in an improved system for creating an enhanced virtual reality environment providing an integrated, universal, communication, monitoring and/or control experience, even for those compromised users typically denied such experience, the system providing newly emergent properties not present in the individual modules of the system, but for the synergy with each other created through the vehicle of the user's mind, a control subsystem comprising:
an r.f. and/or i.f. wireless link communication subsystem, said subsystem including at least a set-top unit subsystem either integral or non-integral with a display subsystem, and either internal or external to the display subsystem, adapted for communicating and coordinating a plurality of diverse functions with both a user and the display subsystem;
whereby an environment of total interactive connectivity and comfortable immersion in the outside world is simulated for the user without concomitant need for technical proficiency, and providing an enhanced gestalt for a new and more complex milieu akin to an old and familiar gestalt in a simpler, more comfortable milieu of direct interaction, all belying the greater complexity of the new system technology and wherein the greater complexity of the system technology is perceived by the user as greater simplicity.

120. A control subsystem as set forth in claim 119, wherein the wireless subsystem has a limited range for a specific user which is non-overlapping with the range for any other user.

121. A control subsystem as set forth in claim 119, wherein the range of the wireless link is limited so that it provides a zone dedicated to the user and does not overlap/conflict/interfere with the zone of any other user.

122. A control subsystem as set forth in claim 119, wherein the wireless link range is ½ mile or less.

123. A control subsystem as set forth in claim 119, wherein the wireless link range is approximately ½ mile.

124. A control subsystem as set forth in claim 119, and further comprising:
means for dynamically reprogramming said set-top unit subsystem.

125. A control subsystem as set forth in claim 124, wherein said reprogramming can be accomplished by a user.

126. A control subsystem as set forth in claim 124, wherein said reprogramming can be accomplished by a source external to the user.

127. A control subsystem as set forth in claim 124, wherein said reprogramming can be accomplished by a remote source external to said system.
